(19) United States
(12) Patent Application Publication
(10) Pub. No.: US 2011/0298603 A1
(43) Pub. Date: Dec. 8, 2011

(54) Intersection Collision Warning System

(76) Inventors: Timothy I. King, Tulsa, OK (US); Hazem H. Refai, Tulsa, OK (US)

(21) Appl. No.: 12/985,999

(22) Filed: Jan. 6, 2011

Related U.S. Application Data
(63) Continuation-in-part of application No. 11/714,572, filed on Mar. 6, 2007, now abandoned.
(60) Provisional application No. 60/779,600, filed on Mar. 6, 2006.
(60) Provisional application No. 60/904,715, filed on Mar. 2, 2007.

(51) Int. Cl. B60Q 1/00

(52) U.S. Cl. 340/436

(57) ABSTRACT

A system for detecting a collision in an intersection includes a plurality of vehicle detection sensors, a base station and a warning signal apparatus. The plurality of vehicle detection sensors are positioned preceding the intersection for detecting and transmitting velocity and position data of at least two vehicles. The base station is for receiving the velocity and position data of the vehicles so as to process the velocity and position data of the vehicles to determine the probability of the vehicles colliding. The base station transmits a warning signal when the probability exceeds a threshold. The warning signal apparatus is positioned preceding the intersection. The warning signal receives the warning signal from the base station to alert a driver of one of the vehicles of an imminent collision.

### CROSS REFERENCE TO RELATED APPLICATIONS

This application is a continuation in part of U.S. Ser. No. 11/714,572 filed on Mar. 6, 2007, now abandoned, which claims the benefit under 35 U.S.C. 119(e) of U.S. Provisional Application Ser. No. 60/779,600, filed Mar. 6, 2006, and also claims the benefit of U.S. Provisional Application “A Warning System for Collision Avoidance at Highway Intersections”, filed Mar. 2, 2007, and identified by Ser. No. 60/904,715. The content of each patent application set forth above is hereby expressly incorporated by reference herein in their entirety.

### STATEMENT REGARDING FEDERALLY SPONSORED RESEARCH AND DEVELOPMENT

This invention was made with government support under NSF-ECCS 0725801 awarded by the National Science Foundation. The government has certain rights in the invention.

### BACKGROUND OF THE INVENTION

1. Field of the Invention

The present invention relates generally to warning systems, and more particularly, not by way of limitation, to an intersection collision warning system for detecting an imminent collision between automotive vehicles.

2. Brief Description of the Prior Art

There have been many recent advances in the transportation industry to solve the collision problems that plague the roadways. In spite of all these advances, very little has been developed for safety at traffic intersections. Many of the most disastrous collisions happen in rural intersections. Crashes related to intersections in the United States resulted in almost 9,000 fatalities and about 1.5 million injuries in 2001 alone. The National Safety Council estimates that 32 percent of all rural crashes occur at intersections and 16 percent of all fatalities on rural highways are intersection related.

In the Traffic Safety Facts 2004 report, the National Highway Traffic Safety Administration (NHTSA) estimated that the economical cost related to vehicle crashes in the year 2003 was $230 Billion, an increase of 50% over the cost in 1998. With a growing number of vehicles populating roadways, these costs are expected to increase unless better safety mechanisms are employed.

The National Highway Traffic Safety Administration (NHTSA) conducted a study in cooperation with the Crash Avoidance Metrics Partnership (CAMP) in addition to GM and Ford motor companies to assess individual crash avoidance technologies on the market today. The technologies and the crash types they attempt to resolve are shown below.

TABLE 1
CAMP research on Crash Avoidance Technologies^{[4]}

| | | | | | | | | | | |
|---|---|---|---|---|---|---|---|---|---|---|
| | | | Blind | Lane | Lane | Collision | Electronic | Roll | | |
| 2003 GES Data | Crash | ACC/ | Zone | Departure | Keeping | Mitigation | Stability | Stability | Backing | Night |
| Crash Type | Frequency | FCW | Warning | Warning | Assistant | by Brake | Control | Control | Warning | Vision |

| | |
|---|---|
| Rear-end | 1,774,756 |
| Crossing Paths | 1,559,321 |
| Off-Road | 1,477,684 |
| Lane Change | 569,677 |
| Animal | 314,043 |
| Other | 175,285 |
| Opposite Direction | 154,527 |
| Backing | 130,521 |
| Pedestrian | 66,650 |
| Pedalcyclist | 48,192 |
| Object | 31,126 |
| Undefined | 11,433 |
| Untripped Rollover | 4,567 |

Based on the research shown in Table 1, crossing path collisions are the second most frequent crash. Approximately 25% of all crashes are of the crossing path type according to this table. The research found that none of the driver assistance systems reviewed address crossing path crashes. This study exemplifies the deficiency in driver assistance systems for reducing intersection collisions.

Intersections are complex and there are different types of intersections as shown in FIG. 1. The different intersection types include skewed road intersections, perpendicular intersections, and multiple approach intersections. Other intersection configurations include railroad intersections. Railroads can intersect a single road or intersect at a two road junction. Each road at an intersection may have the option of using right turn lanes as well. There are further considerations that go into an intersection configuration. These include the number of lanes on each road, the number of stop signs, whether it be one, two, or four. Another consideration is if there are side streets or parking lots letting off onto the road near intersections. An intersection may have multiple inlets and outlets for vehicles to enter and exit on a street. Additionally, there may be a number of vehicles approaching in each lane at an intersection. In addition, as a vehicle approaches an intersection, the vehicle may be affected by the vehicle type, weather conditions and driver input. There is limited technology available to address this problem.

To this end, a need exists to provide a system that has a point of view external to the vehicle so as to provide more information than any one driver can see. Although warning systems of the existing art are operable, further improvements are desirable to improve driver safety and to decrease the number of intersection collisions.

It is to such an intersection collision warning system that the present invention is directed.

### BRIEF DESCRIPTION OF THE SEVERAL VIEWS OF THE DRAWINGS

FIG. 1 is a schematic of different types of road intersections.

FIG. 2 is an intersection collision warning system (ICWS) constructed in accordance with the present invention positioned in an intersection.

FIG. 3 is a block diagram of the integrated ICWS.

FIG. 4 is a functional decomposition of a vehicle detection node of the ICWS.

FIG. 5 shows a magnetic field disruption by a vehicle.

FIG. 6 shows a Wheatstone bridge configuration in a magnetic sensor.

FIG. 7 is a schematic representation of a simple vehicle detection sensor.

FIG. 8 is a schematic representation of a vehicle detection circuit.

FIG. 9 is a graphical representation of the measurement of sensor voltage from a vehicle disturbance.

FIG. 10 is a schematic representation of the transmission timing of a TinyOS Smart Dust Radio.

FIG. 11 is a table providing a cross sectional comparison of Berkeley Nodes.

FIG. 12 is a diagrammatical representation of a Telos® Node.

FIG. 13 is a functional decomposition for a base station of the ICWS.

FIG. 14 is a perspective representation of embedded warning lights at an intersection.

FIG. 15 is a schematic representation of a warning signal.

FIG. 16 is a perspective representation showing installation of an embedded warning light system.

FIG. 17 is a perspective representation of a lighting system node.

FIG. 18 is a perspective representation of warning lights positioned about a stop sign.

FIG. 19 is a perspective representation of a housing for a vehicle detection sensor.

FIG. 20 is a perspective representation of a housing for the base station.

FIG. 21 is a system context diagram of a sensor node.

FIG. 22 is a system context diagram for a base station transceiver.

FIG. 23 is a system context diagram for a collision detection software.

FIG. 24 is a state transition diagram for outer vehicle detection sensors.

FIG. 25 is a state transition diagram for “Stopped Vehicle” detection nodes.

FIG. 26 is a state transition diagram for a base station transceiver.

FIG. 27 are states for collision detection software.

FIG. 28 shows application packet data.

FIG. 29 is a screenshot of a graphical user interface front page.

FIG. 30 is a screenshot of a graphical user interface traffic graph page.

FIG. 31 is a flowchart of the main ICWS software.

FIG. 32 is a schematic representation of a grouping of vehicle detection sensors preceding an intersection.

FIG. 33 is a flow chart for processing data once it comes in over a serial port.

FIG. 34 is a flowchart for detection logic.

FIG. 35 is a schematic representation of digital logic for collision detection.

FIG. 36 is a block diagram of another embodiment of a vehicle detection sensor node that can be used in the intersection collision warning system to detect the identities of vehicles and then to send a warning to a warning signal apparatus associated with particular vehicles to alert the drivers of an imminent collision.

FIG. 37 is a block diagram of an embodiment of a warning signal apparatus adapted to be carried by a vehicle for warning the drivers of vehicles to avoid an imminent collision.

FIG. 38 is a flow chart of a process for predicting a collision between two vehicles within a collision area and providing a warning to the warning signal apparatus within the two vehicles to avoid the collision.

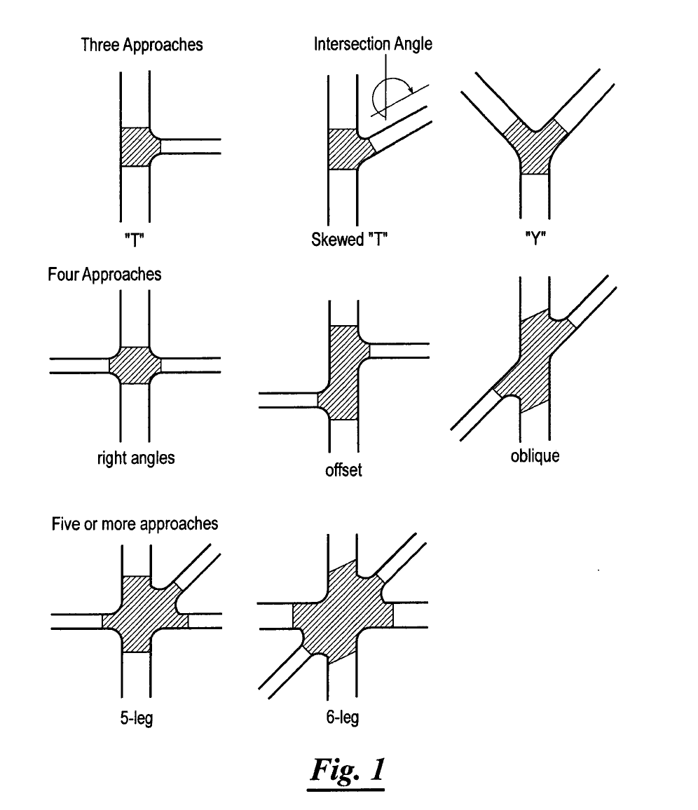

### DETAILED DESCRIPTION OF THE INVENTION

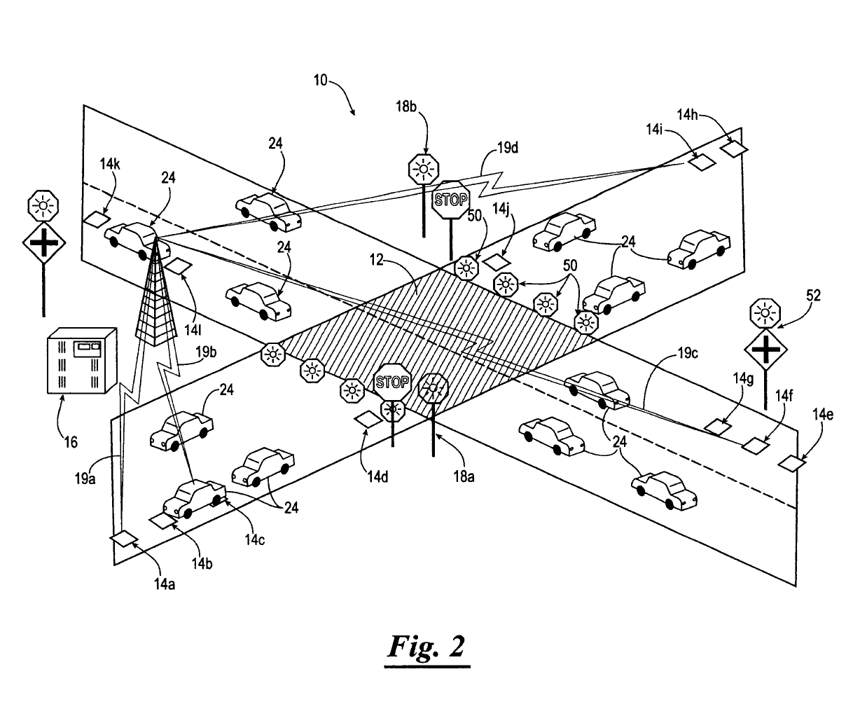

Referring now to the drawings, and more particularly to FIG. 2, shown therein is an intersection collision warning system (ICWS) 10 constructed in accordance with the present invention being shown positioned about an intersection or collision area 12. The ICWS 10 is used to help motorists avoid collisions at existing intersections by detecting impending collisions and warning the motorists. Although FIG. 2 shows the ICWS 10 positioned at the intersection of a highway and street, it should be understood that the ICWS 10 may be positioned in the roadway of any rural or urban intersection.

In general, the ICWS 10 includes a plurality of vehicle detection sensors 14 (labeled in FIG. 2 via the reference numerals 14a-14l for purposes of clarity), a base station 16 and at least one warning signal apparatus 18.

The plurality of vehicle detection sensors 14 is remotely located from the base station 16 and in communication with the base station 16 via a signal path 19 (19a, 19b, 19c, 19d).

The signal paths 19 can be either manual signal paths, or electronic communication signal paths. The electronic communication signal paths can be logical and/or physical links between various software and/or hardware utilized to implement the present invention. The physical links could be air-way or cable communication links. When the invention is implemented, the signal paths may not be separate signal paths but may be a single signal path or multiple signal paths. In addition, it should be understood that the various information does not always have to flow between the components of the present invention in the exact manner shown provided the information is generated and received to accomplish the purposes set forth herein.

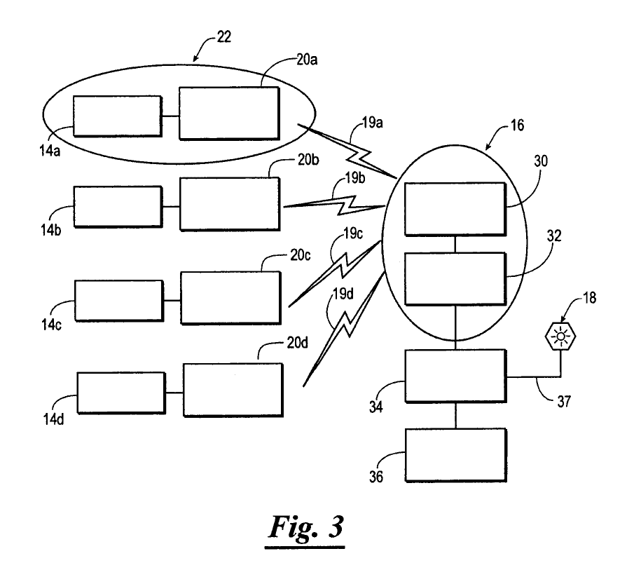

Each of the plurality of vehicle detection sensors 14 may be connected or interfaced with a wireless transceiver 20, as shown in FIG. 3, to form a wireless vehicle detection sensor node 22 to transmit real time vehicle detection data. This wireless network of a plurality of vehicle detection sensor nodes 22 is embedded in the roadways to detect the position and velocity of all vehicles 24 approaching an intersection 12. Although each of the plurality of vehicle detection sensors 14 are shown interfaced with the wireless transceiver 20, it should be understood that each of the plurality of vehicle detection sensors 14 do not have to interface with a communication or network system.

As will be discussed in more detail hereinafter, the plurality of vehicle detection sensor nodes 22 transmit vehicle detection data to the base station 16 by the signal path 19, as shown in FIG. 3. Generally, the base station 16 includes a transceiver 30, a CPU 32, a warning signal 34 and a power supply 36. The base station 16 transmits a warning signal 37 to the warning signal apparatus 18. The warning signal 37 can be either manual signal paths, or electronic communication signal paths. The electronic communication signal paths can be logical and/or physical links between various software and/or hardware utilized to implement the present invention. The physical links could be air-way or cable communication links. When the invention is implemented, the signal paths may not be separate signal paths but may be a single signal path or multiple signal paths. In addition, it should be understood that the various information does not always have to flow between the components of the present invention in the exact manner shown provided the information is generated and received to accomplish the purposes set forth herein.

In order to gather velocity and distance data for each vehicle, a method of vehicle detection and time difference calculation is performed between subsequent detections on each approaching vehicle. To perform time difference calculation, the time of detection is transmitted to the base station 16, as well as location of detection. Also, each of the plurality of vehicle detection sensor nodes 22 is synchronized to the same time. The plurality of detection sensors 14 may be placed in various positions on the roadway. Some of the plurality of detection sensors 14 may be positioned far from the intersection while others may be placed near the intersection. The outer sensors are used to detect approaching speed of vehicles. The near sensors detect stopped vehicles waiting to cross the non-stopping highway traffic. This set-up enables stopped drivers to be warned of approaching vehicles, thus enabling them to know that it is unsafe to cross.

The vehicle detection sensors 14 or vehicle detection sensor nodes 22 may be embedded in the pavement. Additionally, each of the plurality of vehicle detection sensors 14 or the plurality of vehicle detection sensor nodes 22 may fit inside a durable, weather-proof, road button. In one embodiment, the road buttons are 8″ in diameter and can be glued to the pavement for easy installation or placed in the cavity in the pavement. Each sensor is battery powered and can operate for over a year without needing battery replacement. Any two sensors can determine vehicle speed by calculating the time between when each sensor detected an approaching vehicle. The vehicle position and speed information is passed from the sensors to the base station. Sensors are also placed on the intersection close to a stop sign or stop light where vehicles have stopped to cross or merge onto a highway. This position information is used to turn on the beacon to alert motorists not to cross or turn onto the street in case there are vehicles approaching on the street at an unsafe speed or distance.

It is possible to sample position and speed of a car in a number of different ways. Utilizing this information, a system can perform a number of different deterministic approaches to predict the speed and position in the future. Knowing a few samples of the vehicle's time at certain distances from the intersection helps realize the time period when the vehicle is in the intersection. If this calculation is performed for all approaching vehicles, it is possible to determine, within a certain percentage of error, if any of the estimated time periods for when the vehicles are expected to enter and leave the collision zone overlaps. If any of the estimated time periods do in fact overlap, then there is a high probability that there could be a collision.

Referring to FIGS. 3 and 4, a functional decomposition is shown of all the main functions and components of each of the plurality of vehicle detection sensor nodes 22. The four main subsystems of the plurality of vehicle detection nodes 22 are the vehicle detection sensors 14, the radio transceiver device 20, a CPU 42, and a power supply 44. The main internal components that each system contains as well as the energy transformations and descriptions coming out of each subsystem are shown. The inputs of each of the vehicle detection sensor nodes 22 are the environment, mainly disturbances in the environment from approaching vehicles 24, and incoming data from the base station 16. The vehicle detection sensors 14 sense the changing environment which tells the CPU 42 the presence of the vehicle 24. This data changes to digital information and then is used to trigger the CPU 42 to transmit information. The transceiver 20 has an IEEE 802.15.4 MAC layer subsystem that performs packet transmission coordination to prevent packet collisions in the system. The final packet is transferred through the antenna to the destination. The antenna receives broadcasts from the base station 16 for synchronizing the clocks of each vehicle detection sensor node 22. When this information is received, the data signals the CPU 42 to reset its clocks to the appropriate time.

There are multiple vehicle detection sensors 14 that have been reviewed by the Vehicle Detector Clearing House Corporation in a study sponsored by the FHWA. These sensors have been reviewed in the following table.

TABLE 2
Vehicle Detection Technologies Available on the Market Today^{[28]}

| Technology | Strengths | Weaknesses |
|---|---|---|
| Inductive | Flexible design to satisfy large | Installation requires pavement cut. |
| Loop | variety of applications. | Decreases pavement life. |
| | Mature, well understood | Installation and maintenance require lane closure. |
| | technology. | Wire loops subject to stresses of traffic and |
| | Provides basic traffic parameters | temperature. |
| | (e.g., volume, presence, occupancy, | Multiple detectors usually required to instrument a |
| | speed, headway, and gap). | location. |
| | High frequency excitation models | |
| | provide classification data. | |
| Magnetometer | Less susceptible than loops to | Installation requires pavement cut. |
| (Two-axis | stresses of traffic. | Decreases pavement life. |
| fluxgate | Some models transmit data over | Installation and maintenance require lane closure. |
| magnetometer) | wireless RF link. | Some models have small detection zones. |
| Magnetic | Can be used where loops are not | Installation requires pavement cut or tunneling |
| (Induction or | feasible (e.g., bridge decks). | under roadway. |
| search coil | Some models installed under | Cannot detect stopped vehicles. |
| magnetometer) | roadway without need for pavement | |
| | cuts. | |
| | Less susceptible than loops to | |
| | stresses of traffic. | |
| Microwave | Generally insensitive to inclement | Antenna beamwidth and transmitted waveform |
| Radar | weather. | must be suitable for the application. |
| | Direct measurement of speed. | Doppler sensors cannot detect stopped vehicles. |
| | Multiple lane operation available. | |
| Infrared | Active sensor transmits multiple | Operation of active sensor may be affected by fog |
| | beams for accurate measurement of | when visibility is less than [symbol] 20 ft or blowing |
| | vehicle position, speed, and class. | snow is present. |
| | Multizone passive sensors measure | Passive sensor may have reduced sensitivity to |
| | speed. | vehicles in its field of view in rain and fog. |
| | Multiple lane operation available. | |
| Ultrasonic | Multiple lane operation available. | Some environmental conditions such as |
| | | temperature change and extreme air turbulence can |
| | | affect performance. Temperature compensation is |
| | | built into some models. |
| | | Large pulse repetition periods may degrade |
| | | occupancy measurement on freeways with vehicles |
| | | traveling at moderate to high speeds. |
| Acoustic | Passive detection. | Cold temperatures have been reported as affecting |
| | Insensitive to precipitation. | data accuracy. |
| | Multiple lane operation available. | Specific models are not recommended with slow |
| | | moving vehicles in stop and go traffic. |
| Video Image | Monitors multiple lanes and | Inclement weather, shadows, vehicle projection |
| Processor | multiple zones/lane. | into adjacent lanes, occlusion, day-to-night |
| | Easy to add and modify detection | transition, vehicle/road contrast, and water, salt |
| | zones. | grime, icicles, and cobwebs on camera lens can |
| | Rich array of data available. | affect performance. |
| | Provides wide-area detection when | Requires 50- to 60-ft camera mounting height (in a |
| | information gathered at one camera | side-mounting configuration) for optimum |
| | location can be linked to another. | presence detection and speed measurement. |
| | | Some models susceptible to camera motion caused |
| | | by strong winds. |
| | | Generally cost-effective only if many detection |
| | | zones are required within the field of view of the |
| | | camera. |

The sensors in Table 2 can be further broken down into two types, intrusive and non-intrusive sensors. Intrusive sensors are defined as those that are embedded into the roadway requiring cuts in the pavement and lane blocking for construction worker's safety. Non-intrusive sensors are those that are built above the ground or beside the roads. The applications of each of these sensors are further displayed in Table 3.

TABLE 3
Vehicle Detection Sensor Summary^{[28]}
Traffic sensor output data, bandwidth, and cost (Klein, 2001)

| | | | | | | Multiple | | |
|---|---|---|---|---|---|---|---|---|
| | | | | | | Lane, | | |
| | | | | | | Multiple | | |
| | | | | | | Detection | | Sensor Purchase |
| | Output Data | | | | | Zone | Communication | Cost¹ |
| Technology | Count | Presence | Speed | Occupancy | Classification | Data | Bandwidth | (each in 1999 $) |
| Inductive loop | X | X | X² | X | X³ | | Low to | Low⁹ |
| | | | | | | | moderate | ($500 to $800) |
| Magnetometer | X | X | X² | X | | | Low | Moderate |
| (Two-axis | | | | | | | | ($1,100 to $6,300) |
| fluxgate) | | | | | | | | |
| Magnetic | X | | X² | X | | | Low | Low to moderate⁹ |
| (Induction or | | | | | | | | ($385 to $2000) |
| search coil) | | | | | | | | |
| Microwave radar | X | X⁴ | X | X⁴ | X⁴ | X⁴ | Moderate | Low to moderate |
| | | | | | | | | ($700 to $3,300) |
| Infrared | X | X | X⁵ | X | X⁶ | X⁶ | Low to | Low to high |
| | | | | | | | moderate | (Passive: $700 to |
| | | | | | | | | $1,200; Active $6,500 |
| | | | | | | | | to $1,900) |
| Ultrasonic | X | X | | X | | | Low | Low to moderate |
| | | | | | | | | (Pulse model: $600 to |
| | | | | | | | | $1,900) |
| Acoustic Array | X | X | X | X | | X⁷ | Low to | Moderate |
| | | | | | | | moderate | ($3,100 to 8,100) |
| Video image | X | X | X | X | X | X | Low to high⁸ | Moderate to high |
| processor | | | | | | | | ($5,000 to $28,000) |

¹Installation, maintenance, and repair costs must also be included to arrive at the true cost of a sensor solution as discussed in the text
²Speed can be measured by using two sensors a known distance apart or by knowing or assuming the length of the detection zone and the vehicle.
³With specialized electronics unit containing embedded firmware that classifies vehicles.
⁴From microwave radar sensors that transmit the proper waveform and have appropriate signal processing.
⁵With multi-detection zone passive or active mode infrared sensors.
⁶With active mode infrared sensor.
⁷Models with appropriate beam forming and signal processing.
⁸Depends on whether higher-bandwidth raw data, lower-bandwidth processed data, or video imagery is transmitted to the traffic management center.
⁹Includes underground sensor and local receiver electronics. Receiver options are available for multiple sensor, multiple lane coverage.

The following are factors considered when selecting a sensor: 1) accurate position and location data from all points for collision detection; 2) high speed vehicles accurate position data; 3) Low speed vehicles accurate speed data; 4) cost of distribution; 5) cost of equipment and manufacturing; 6) installation costs; 7) maintenance and calibration; 8) powering the product; and 9) cost of development.

For this system, multiple sensors are installed so the low cost factor is important in developing this system. Of all the sensors displayed in the tables, the magnetic sensors (inductive loops, magnetometer, and magnetic sensors) seem to be the least cost. Other sensors have higher cost, because of an immense amount of filtering and processing that is performed on these sensor readings. This is due to their unreliability in accurately detecting vehicles. Magnetic sensors are not as susceptible to environmental conditions such as fog, rain or temperature unlike the other sensors displayed in the tables. Another factor is that the system is able to detect stopped vehicles. Therefore, this narrows the sensors down to inductive loops or magnetometers. Inductive loops are bulky and difficult to install, so the sensor choice for this system is the magnetometer.

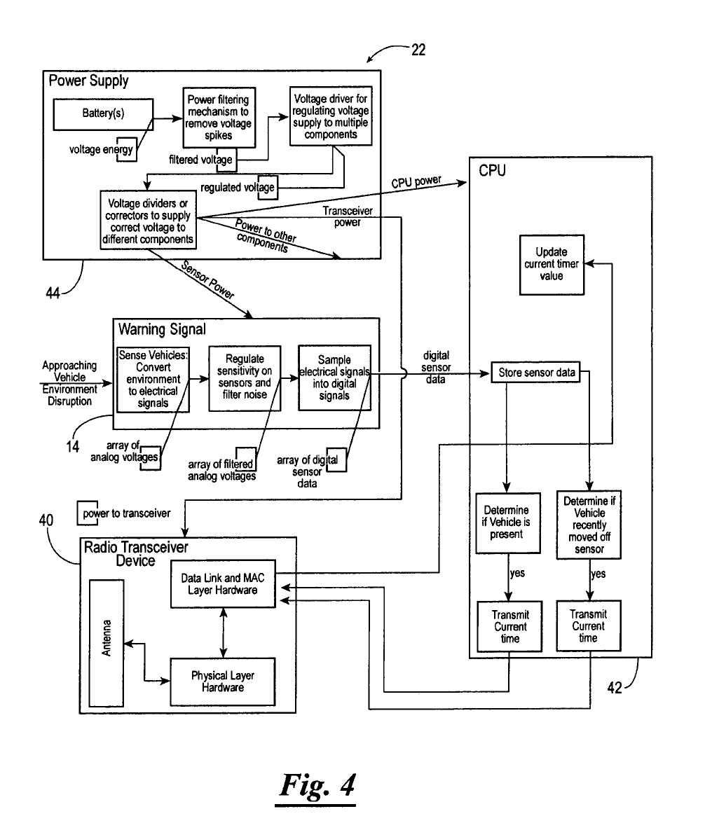

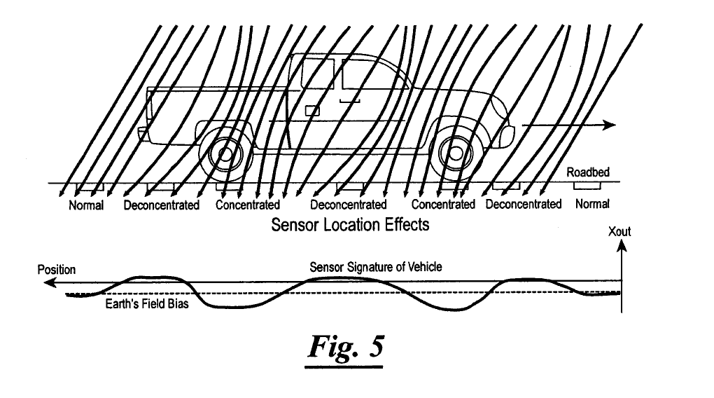

Another technology presented in Table 3 is the magnetometer. Since all vehicles have some amount of ferrous material due to the steel framing in vehicle design, every vehicle emits a magnetic field disruption. The magnetometers or magnetic sensors are able to detect this disruption, as shown in FIG. 5.

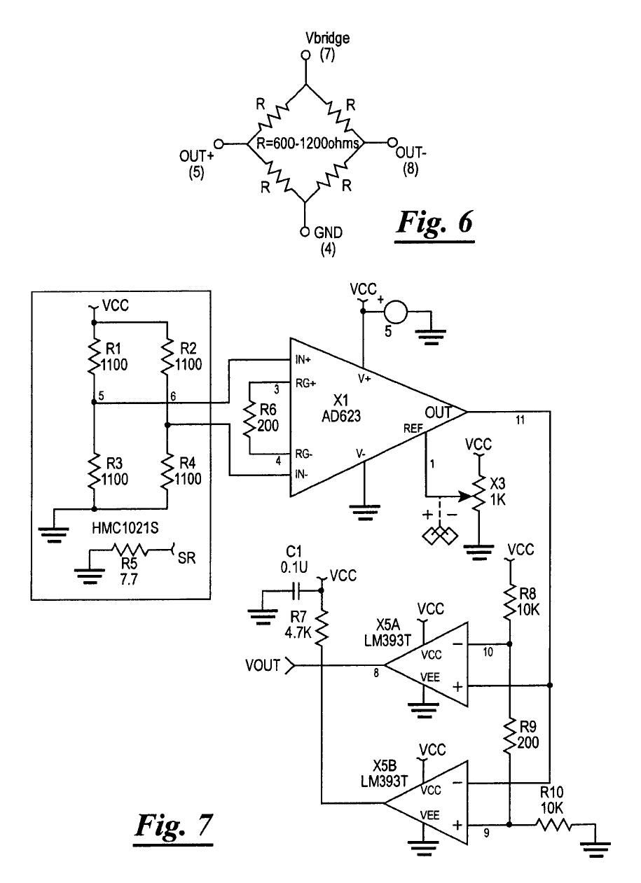

An excellent manufacturer for magnetic/magnetometer sensors is Honeywell, who manufactures an extensive array of different sensors for different applications. One type of sensor chosen for this project is the Honeywell HMC1021Z single-axis magnetic sensor. The magnetic sensor employs a Whetstone bridge consisting of four nickel-iron magneto-resistive resistors as shown in FIG. 6. When a magnetic field is applied in the correct sensitive axis, the voltage output is changed as a result, depending on the strength of the magnetic field. This sensor comes in a low cost convenient SMT package. It should be understood that any sensor known by one of ordinary skill in the art for detecting the velocity and position of a vehicle may be used in the present invention so long as the sensor functions in accordance with the present invention.

In Table 3, magnetic sensors can be interfaced with RF transmission devices. An excellent device to interface with these devices is a new technology known as smart dust. One popular manufacturer of these magnetometers interfaced with smart dust is Sensys Networks. This company embeds magnetic sensors interfaced with Berkeley nodes to transmit vehicle detection data wirelessly to local access points.

A simple vehicle detection circuit can be built utilizing an AD623 amplifier along with LM393 comparator chips to output a logic high signal if there is a vehicle present or a logic low signal if there is not. The schematic shown in FIG. 7 shows a simple vehicle detection sensor.

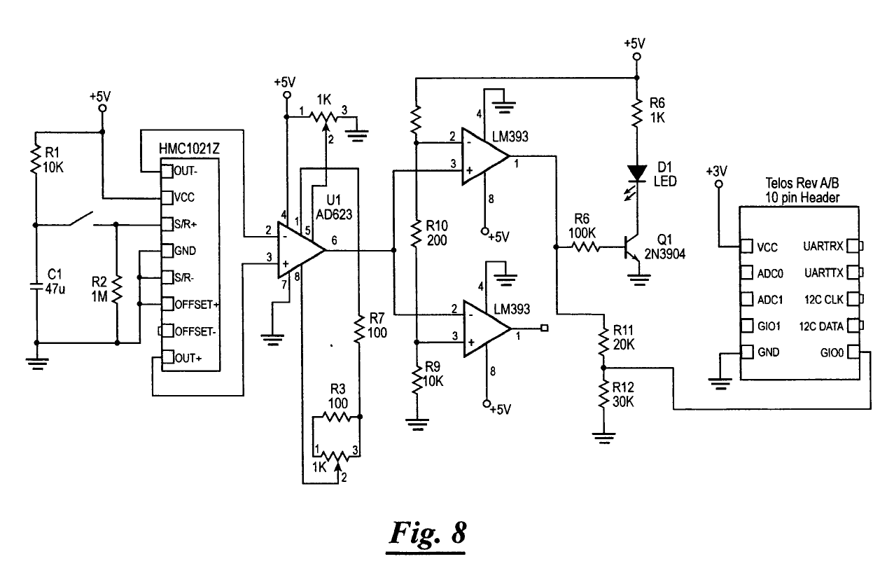

Additional components can be added to filter out noise on this circuit. The schematic shown in FIG. 7 implements a 200 ohm resister between the gain inputs, which implements a gain of 500. In the actual design for this system, this resistor has been replaced with a potentiometer that can sweep from 100-200 ohms allowing for a gain of 500 to 1000. The large amplification from utilizing the AD623 chip can lead to major interference especially from cell phones. Utilizing 1 μF capacitors, on the inputs to the amplifiers, filter out most of these problems. An example of a full schematic of the vehicle detection circuit is shown in FIG. 8.

The voltage output from AD623 in this circuit is logged while moving it underneath a vehicle. FIG. 7 shows the voltage output.

The voltage range for the output of the circuit is approximately 0.5 volt, between 2.4 and 2.9 V. As shown in FIG. 9, spikes occur while the sensor is underneath the vehicle axles, and it has a moderate increase in voltage while the vehicle is over the sensor. The comparator level is set in this voltage range to output the digital logic to the wireless node processor. Interfacing this schematic with a wireless sensor node makes a very cheap and reliable vehicle detection sensor to be utilized for the present invention.

Sensor placement is very important in order to make sure that collision warning is displayed to drivers in time for them to react. To determine the correct distance from the intersection, it is important to consider the one-dimensional motion model, in a straight path.

$$Δ d = {v}_{0} t + \frac{1}{2} a \cdot {t}^{2}$$

Δd is the change in distance, v₀ is the change in velocity, a is the acceleration and t is the elapsed time.

Finding the change in distance (Δd) determines the distance in which the set of sensors is placed from the intersection. The inputs are the initial velocity, the acceleration and the elapsed time. There is a large array of possible values that these could be for an intersection. The challenge is to assume a single distance that makes this system work for a large array of different inputs. Thus, to warn any approaching driver in all scenarios, one can assume the worst case scenario for the intersection.

For example, brake performance on unloaded trucks given dry road conditions and good pavement conditions can be up to 7 m/s² deceleration for steady state. If the truck is driving the speed limit in a 40 mph speed zone and begins deceleration at this rate, the truck stops in approximately 23 meters. However, in icy conditions the braking performance is degraded down to around 1 m/s² deceleration, so in this case it takes 158 meters to decrease speed to a stop. The average observed deceleration distance on roads with approach speeds of 37-43 mph in dry conditions is approximately 133.9 m. Considering this information, designing for worst case scenario gives warning to drivers at a distance of approximately 25 m before the point that they normally begin deceleration. The design speed that many road designers choose in assuming traffic behavior is 10 mph above the speed limit. The same consideration is used as a rule of thumb when installing this system at a specific intersection. The total distance that a sensor is placed from an intersection is greater than the sum of the distance traveled during processing time, deceleration distance, and the reaction distance. In a study on driver reaction times, the reaction time for the elderly is around 1.1-1.3 seconds. This is considered as the worst case scenario for the ICWS. For a 40 mph speed zone designing for less than optimal road conditions making average deceleration rates 2 m/s² and taking into account slow reaction time for the elderly as well as the +10 mph design speed, this makes the total length from the intersection, approximately 150 meters. The equation for this is:

d=vᵢ(t_{reaction}+t_{processing}+tₛₜₒₚ)+½a·tₛₜₒₚ²

vᵢ is the speed limit +10 mph, t_{reaction} is 1.1 seconds for the elderly, and a is the less than optimal deceleration rate (−2 m/s²). tₛₜₒₚ is the deceleration period comes to a full stop from the initial velocity. This is defined as tₛₜₒₚ=vᵢ/a. This equation is computed for each possible location where the ICWS 10 is installed.

Most vehicles are warned before they begin initial deceleration; however, giving all vehicles early warning ensures that those who have not considered the approaching intersection are warned in adequate time.

Three subsequent sensors are used in series to determine position, speed and a speed update. The distance between sensors is equal to enable simple speed computation. The distance between subsequent sensors is approximately over a car length. The average car length is approximately 4 m; therefore the spacing of the sensors is approximately 5 m apart. The main purpose in deciding this distance is ensuring that enough time has passed between subsequent sensor readings to limit data corruption or heavy latency from simultaneous transmissions. The varying density of ferrous material in a vehicle results in multiple detections for a single vehicle, so a single detection is followed by an idle time that is the approximate time that a car completely passes over the sensor. Once again, this value is based on the expected vᵢ for the particular intersection area. The idle time ensures that only one sensor reading is read per vehicle. If a large vehicle that spans multiple car lengths passes over the sensor, the vehicle is detected as 2 or more separate cars.

One advantage of using magnetic sensors is that they can be interfaced with wireless transceivers. A recent innovation in wireless design is the technology known as Smart Dust. Smart Dust is being used for a large array of applications in many different fields ranging from military surveillance to biomedical research. Smart Dust is optimal for its small size, low cost and adaptability. Smart Dust consists of an on board wireless transceiver and microprocessor.

One motivation in the selection of smart dust is its capability of wireless node to node communication. This is important due to the adverse conditions in which the sensors are placed, as well as valid data reception.

The following are factors to the networking of the ICWS 10: throughput (Data Rate), Capacity, Connectivity, Packet Loss, and Security. Throughput is defined as the rate in which the network sends and receives data. This is based upon data preparation, available network bandwidth, and latency. These networks have a slower data rate due to their single packet at a time transmission and individual routing.

The capacity for this particular technology is strictly dependent upon the operating system for the wireless sensor nodes. In general, most Smart Dust technologies use the TinyOS operating system developed by University of California, Berkeley. TinyOS is the program structure in which all Smart Dust applications are built upon. The most recent revisions include updates to the source code that enables more capacity to the nodes. Most recent versions can handle reception of over 50 packets per second. This could handle the traffic of numerous of nodes at a time.

Connectivity has a single node that senses its neighboring nodes and communicates connection and synchronization parameters. Depending on the application used for the Ad Hoc routing, this can be fairly slow. The present invention utilizes a broadcast scheme removing the need for this network layer component. This simplifies this communication process.

Packet loss is the metric for characterizing the reliability of a node to node connection within the application layer of the OSI. It is synonymous with bit error rate within the MAC layer and Received Signal Strength within the physical layer. There are some limitations to using packet loss as a means of characterizing network connection integrity, but for the purposes of performing a high level glance at connection quality, this is a reasonable metric. When discussing packet loss, the metric generally used is yield. This is defined as the ratio of packets received to packets sent. One hundred percent yield is ideal for data transmission.

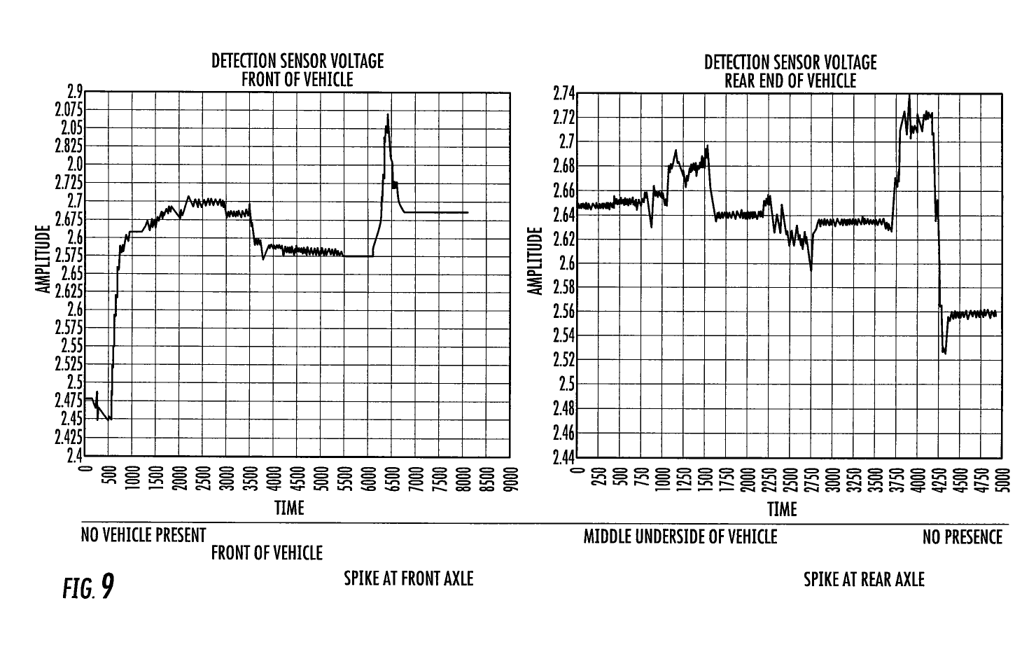

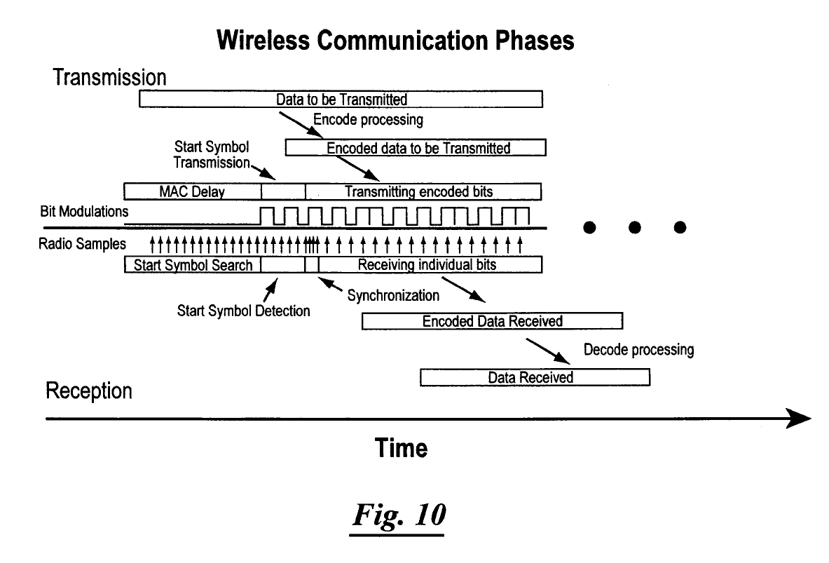

Security is a major issue in many wireless applications, especially in WiFi and cellular communication. To provide some protection against threats, once data buffering is completed, the node performs data encoding and encryption on the data before transmission. FIG. 10 shows the phases in which the nodes perform communication.

The physical medium in which data is transmitted contains a plethora of issues in the networking sphere, such as range, coverage, and interference.

The range for the nodes is dependent upon the type of antenna used, the transmission power and the frequency of transmission. One type of technology used in the present invention is the Crossbow Telos® Rev. B node. Under default power settings and favorable conditions, the transmission range approaches a maximum of 125 m.

Coverage is determined by numerous factors in RF propagation. These include RF reflection, diffraction, scattering, multipath, shadowing, and motion to name a few. Coverage is also dependent on the type of antennas used with the sensor nodes. Different antennas have different propagation patterns, such as an embedded on board antenna. The coverage area for each node is in a circle with a radius of the transmission range. One advantage of ad-hoc networking is that the nodes can be placed in coverage area of a single node. The nodes perform their own connectivity on initialization. Adding more coverage area is a simple matter of adding more nodes. If the transmission distance is too far for the node to transmit to the base station reliably, another node is placed between the base station and transmitter to act as a repeater, cutting the transmission distance in half and allowing for more reliable data transmission.

The interference in the wireless sphere has an impact on connection integrity. The nodes are placed in a zone where node to node transmission is subject to multipath fading due to moving vehicles, EMF noise due to engines and internal automobile parts. It is also subject to RF noise from various consumer electronics used by passengers of vehicles. Thermal noise is an increasing factor as the heat of pavement rises during summer months.

Two existing Smart Dust technologies could be used for the present invention. These technologies include the Crossbow® Mica series, and the Telos® Nodeiv series. Crossbow is one of the largest developers of Smart Dust technology today. Their Mica series nodes are widely used among consumers and developers around the world. The Mica series nodes have been around since 2001, the latest technology being the MicaZ. Mica2 was developed around 2002 and has become the prodigy of the series.

The Mica2 nodes are the most widely used today and implement many important technologies. They are run by the Atmel Atmega 128 processor providing respectable capacity for most Smart Dust applications. It implements a Chipcon CC1000 radio available from 300-1000 MHz. The Mica2's are built for 315 MHz, 433 MHz, and 915 MHz operation providing excellent range of up to 100 m in favorable conditions. The nodes can be programmed over air or individually through the base station that connects to a RS232 serial port on the PC. The nodes are powered by two AA batteries, and using low power applications that only do processing periodically, the nodes can last over a year. Additionally there is a 51 pin expansion connector on each node that provides access to numerous A/D converters and general purpose digital I/O pins on the processor.

The Mica2 nodes have hundreds of sample applications developed for them. There is a wealth of source code provided by Crossbow to allow developers better understanding on application development for this technology.

A brand new Smart Dust technology called the NodeIV is produced by Telos®. This new technology was built upon the IEEE 802.15.4 standard for low power wireless sensor networks. The Telos® nodes provided several advances upon the older Crossbow Mica series nodes. The new nodes retained the TinyOS functionality, but implemented new hardware components that had better performance than the Micas. The Telos® nodes used the TI MSP430 processor enabling lower sleep power and faster wakeup times than the Atmega processor the Micas used. The Telos® nodes use 2.4 GHz radio transmission frequency enabling better bandwidth but less range than the Micas. Telos® nodes implemented three integrated sensors for light, temperature and humidity detection. One of the best modifications to the Micas is that the Telos® nodes communicate to the PC through an integrated USB connector on the nodes. Micas have a base station that connects to the PC via a serial connection. The Telos® modification is better for several reasons. First, there is no need for the extra expense and headache of a base station. Each node has the ability to connect to the PC by itself. Finally, 9 pin serial ports are becoming less common in newer computers, especially laptop computers. USB connections are still widely used in all computers and, for this reason, Telos® nodes are more compatible with newer computers.

FIG. 11 shows a table of comparison between the Crossbow Mica series and the Telos® nodes.

The Telos® has an improved data rate over the Mica2 nodes. According to the table, the data rate is 250 kbps. This is over 6 times the data rate of the Mica2's.

Since the chosen technology transmits data on a public transmission band, interference with other possible technologies is a consideration. The Telos® nodes transmit data on the 2.4 GHz ISM band. This is the same band used for Bluetooth technology and IEEE 802.11 networks. If the ICWS 10 is employed in rural areas, it should not be affected by these technologies since these networks are not expected to be in place in rural areas. However, this technology may be placed in urban areas where needed, and in that case, 802.11 networks may cause conflict. According to a study performed by Siemens Technology, the 802.15.4 standard is the primary channel designed to be a clear channel. IEEE 802.11 has eleven channels within the 2.4 GHz ISM band and each is separated by gaps. The primary 802.15.4 channels are placed at frequencies at the upper end of the 2.4 GHz band near 2.475 GHz. IEEE channels do not encroach on these 802.15.4 clear channels unless transmitting at high power in close range. This strategic channel placement allows the two technologies to share the ISM band without the concern of conflicts.

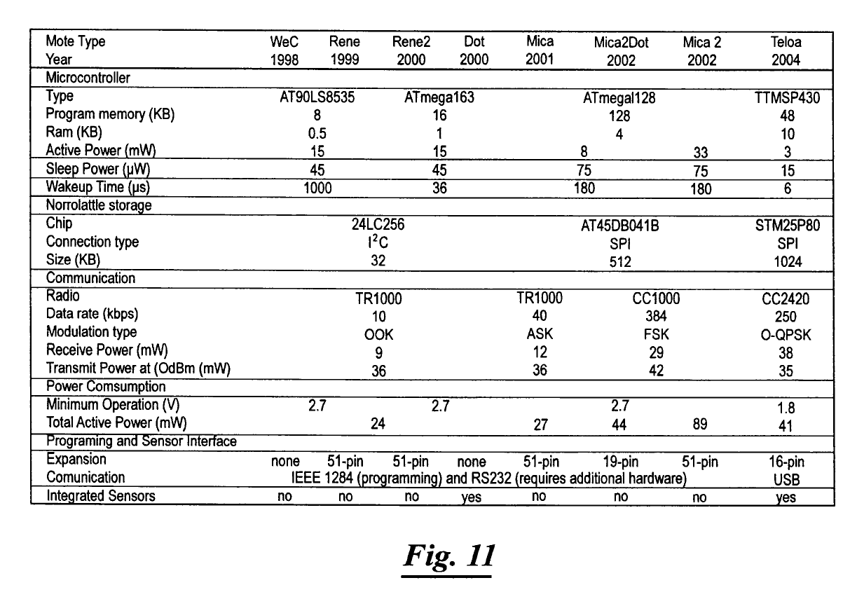

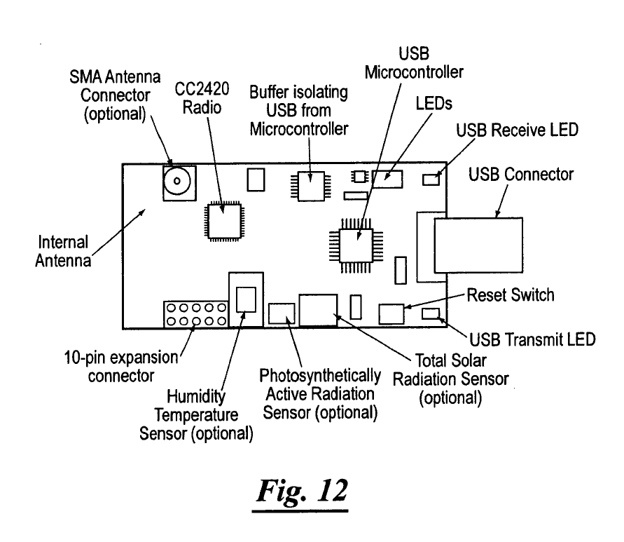

Each vehicle detection sensor is interfaced with a Smart Dust node which consists of an onboard microcontroller. One type of sensor node, the Telos® Rev. B node, contains the TI MSP430 16F149 microcontroller. This microcontroller is an 8 MHz processor with several digital I/O ports and ADC ports. The 10-pin header on the Telos® board, as shown in FIG. 12, makes four digital I/O pins accessible as well as 4 analog I/O pins. The system needs only one digital I/O pin for interfacing the vehicle detection sensor to the Smart Dust board. The GIO0 pin on the 10 pin header is chosen to interface this sensor. In the MSP430 the GIO0, and GIO1 pins are referenced as general I/O pins on port 2. Each of these pins can be set up as an external interrupt, to serve as a wakeup for the system. The processor interruption signals transmission of the vehicle detection data and local timer value to the base station.

Referring to FIGS. 3 and 13, the base station 16 includes the transceiver 30, the CPU 32, the warning signal system 34, and the power supply 36. The input to this system is simply the sensor readings from the vehicle detection sensor nodes 22. Transmissions from the vehicle detection sensor nodes 22 are received by the antenna and then transmitted through the physical and link layer hardware to the CPU 32. The CPU 32 buffers this information and uses its logic to detect if the data set is enough to perform predictive analysis for the vehicle. Once a predictive analysis is performed for the vehicle, it is compared to other current predictive analyses to determine if there could be an imminent collision. Results of this analysis signals a warning signal system 34. The output is either audible or visual cues to approaching drivers to convey to them that they are on a collision course. Another output of this system is a periodic broadcast of the CPU's 32 current timer value over the wireless transceiver 30 for synchronization of all vehicle detection sensor nodes 22 in the network. The inputs into the base station 16 are the following: speed of each vehicle; location of each vehicle; location of collision zone.

In order to gather speed and location data for each vehicle for the ICWS 10, a method of vehicle detection is executed on each approaching vehicle. Time difference calculation between subsequent vehicle detection sensors is performed to determine the speed of approaching vehicles.

The base station 16 further includes a PC rack utilizing a Labview user interface to retrieve, analyze, and compute the collision analysis on the data coming in from the transceiver. The PC rack has a USB and PCMCIA interface for the current design of this system. The base station transceiver is simply another Telos® node plugged into the USB interface of the PC rack to receive the IEEE 802.15.4 packets from wireless vehicle detection nodes scattered around the intersection. The Telos® node relays all incoming packets to the PC rack and the Labview program parses the data and processes it for collision analysis. The PC rack consists of a PCMCIA interface that controls an NI-6036 data acquisition card consisting of ADC outputs. This enables the base station to output a digital signal to turn on the external warning device.

Any laptop may be used as the PC. One advantage of using a PC is that the customer can simply purchase the software and external interfaces utilized in this system. Customers do not have to purchase any proprietary equipment for the base station processor; they can use their own PC equipment for the processing of this system. Additionally, the PC can be utilized for other applications, not limited to this system alone. It should be further understood that any hardware may be used to function with the base station in accordance with the present invention.

The base station 16 receives data coming from the plurality of vehicle detection sensors 14 in all possible lanes of traffic and performs a predictive analysis and logic algorithm to determine if any two approaching vehicles are on a collision course. The base station 16 utilizes DSP technology to quickly process data coming from the sensors and determine collision probabilities in a timely fashion. The base station 16 is housed in a weather proof cabinet and is positioned close to the intersection so it can easily send and receive wireless data from all nodes. The base station 16 is solar powered and can operate on a backup battery for an extended period of time.

In the case of an impending collision, the base station triggers the warning signal apparatus 18. The warning signal apparatus 18 is intended to capture the attention of an approaching driver in ample time for them to slow down and stop before the intersection. In one embodiment, the warning signal apparatus 18 is a beacon light which can either be mounted on a pole next to the stop sign or on the stop sign itself or any other position suitable for being observed by a vehicle near or in the intersection. The beacon lights contain low power LED lights which also are solar powered and can operate on a backup battery. Other modes of alerting the vehicles are also intended to be covered by the present invention. Designing effective warning signals for drivers is a fairly complex process which has been the subject of many psychological studies. One goal is that the warning system is effective at capturing driver's attention, and is accurate as to gain the driver's trust, so they willingly react to the warning signals. Passive stop signs have not been effective at capturing the driver's attention to stop, mainly because they tend to blend in to the background. According to a psychological study, the human sensory cortex has evolved to adapt, predict and quiet down statistical regularities of the world. The best method of capturing a driver's attention is through the presence of a new object that has not been in place before. This is known as the new object stimulus. The warning signal turns on when the vehicle is on a collision course. The irregularity of signals is more effective at capturing driver's attention than passive stop signs alone.

The two possible stimuli for an external warning system are visual and audible stimuli. The present invention uses lighting as the visual stimulus. However, it should be understood that any known visual and audible stimuli known to one of ordinary skill in the art may be used.

The warning signal is an external light to flash to the driver if they are on a collision course with another vehicle. Blue lights are used in the present invention since the human brain is most sensitive to the color blue in daytime light. However, it should be understood to one of ordinary skill in the art that any color may be used as the external light. To effectively serve as a visual cue, the length of time the light signal stays on is at least 600 ms. For the present invention, the duration for the warning signal is set to 850 ms in order to capture a driver's attention.

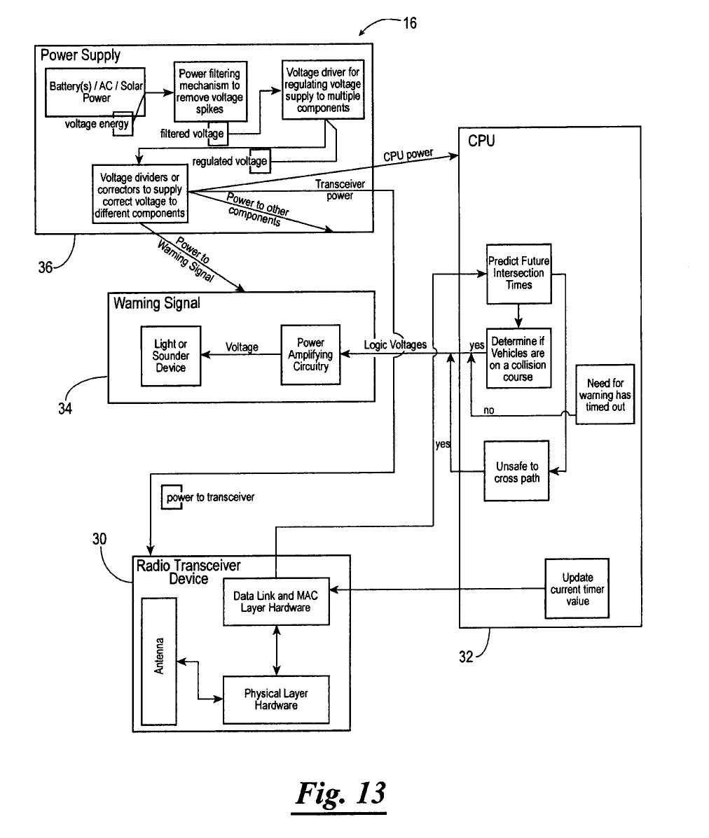

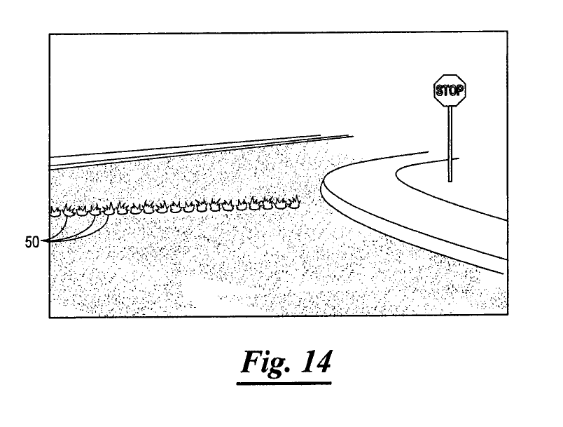

Studies have been performed to investigate the optimal placement of warning lights to effectively capture a driver's attention. According to a study performed by Whitlock & Weinberger Transportation Inc., embedding lights into the pavement serve better at capturing driver's attention than utilizing overhead lights. This is due to the fact that overhead lights blend into the background and drivers are less receptive to them. Embedded pavement lights are used at crosswalks and school zones so that drivers are more receptive to the caution areas. The present invention seeks to utilize embedded pavement lights in the warning system. A string of LED lights 50 are spread just before the intersection zone to capture the approaching driver's attention, as shown in FIGS. 2 and 14. LED lights have been chosen because of their long lasting qualities and low power consumption.

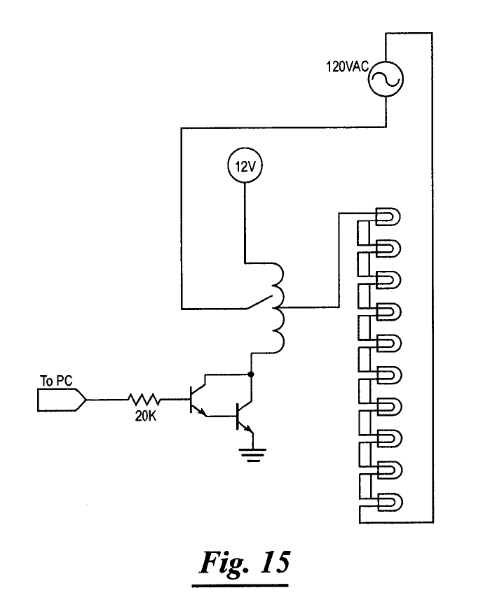

A string of 50 LED lights which plug into a 120 volt AC power source is used as the lighting source. The system operates at 450 mW so the lights draw very little current, but provide adequate brightness. To turn on the lights, a relay/transistor switch is utilized coming from the PC. FIG. 15 shows a basic schematic for this system.

Additional warning lights mounted on the stop sign or beside it would provide additional visual reception. The vehicles that are waiting to cross at the stop sign need to be close to the intersection to view the embedded lights in the ground, so a signal mounted on the stop sign provides another visual cue to the drivers.

Solar panels and battery sources may be used to power the ICWS 10. The vehicle detection sensor nodes operate at low power and can survive for a long time on battery power. Their current consumption is on the order of 50 mA continuously. 2000 mAH batteries may be utilized. With the existing current consumption, the sensor nodes can survive a couple of days of continuous operation before the batteries need to be changed. To facilitate longer power operation, the sensors can be equipped with their own solar cells which facilitate longer power operation and battery recharging. However, it should be understood that any power source may be utilized to provide the necessary power to the ICWS 10.

Packaging for the ICWS 10 components is simplified by purchasing off-the-shelf products that have already been tested for vehicle stress. For the embedded lighting system used to warn drivers of collisions, an off-the-shelf product is available from Traffic Safety Corp. Utilization of off the shelf products also ensures that they adhere to Federal Highway codes and restrictions.

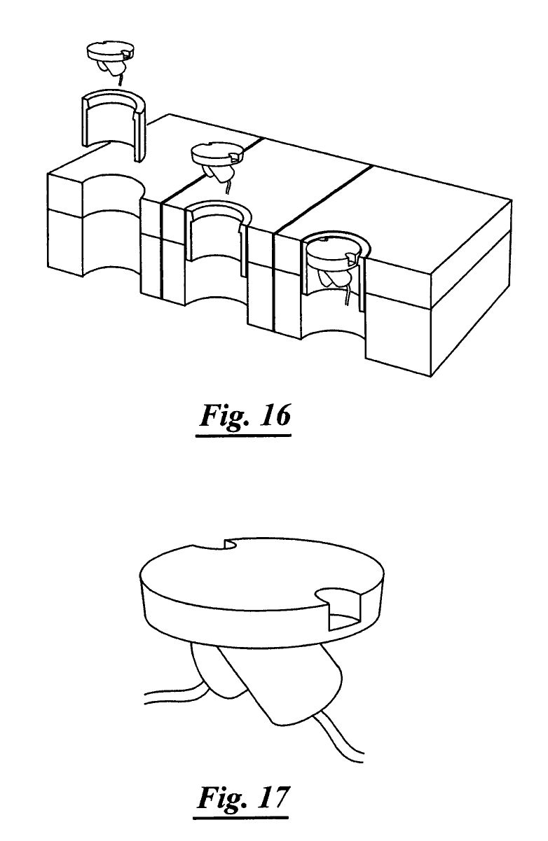

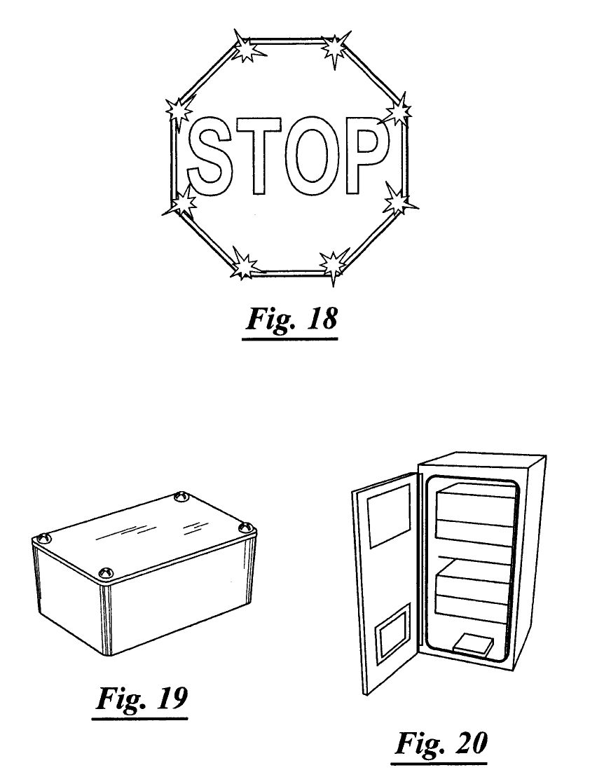

For example, FIG. 16 shows how the casing of the system is embedded into the pavement. FIG. 17 shows the lighting system module without its casing. By hooking the input of this lighting system to the collision warning output from the PC rack, the system can be used for this application. As an aid to the embedded lighting system, another component is to be utilized with the warning system to supply a yield sign or the stop sign with warning lights as well (FIGS. 2 and 18). LED lighted stop signs are other off-the-shelf products available from TAPCO, Inc., as shown in FIG. 18.

The lighted stop sign is also triggered by the collision warning output, connected in parallel with the embedded lighting system. This makes up the packaging of the warning system.

The packaging for the vehicle detection sensors is a 6″ by 4″ by 2″ ABS plastic box that can be purchased from Radio Shack, as shown in FIG. 19. The box houses the detection sensors as well as the batteries powering the system. The box keeps the system free from debris and moisture and does not attenuate the wireless signal severely. The box is also embedded into the pavement in the middle of the road away from the path of the vehicle tires.

To house the base station, or more specifically, the PC rack utilized for processing the forward predictive analysis and collision detection, a standard ITS cabinet can be purchased. Northern Technologies provides several solutions for ITS cabinet as shown in FIG. 20. A smaller model of cabinet may be custom built. The ITS cabinets have rack mounting and cooling for the sensitive instruments inside, as well as locks, so that the base station is tamper proof.

Although specific housings have been shown in order to provide examples, it should be understood that any type of covering, housing or structure may be utilized so long as it functions in accordance with the present invention.

The software in the ICWS 10 includes various complex algorithms which work together to enable accurate detection. There are three major hardware devices that each has their own software. These devices are (1) the wireless sensor nodes, (2) the base station PC rack software and (3) the base station transceiver node. Each of these systems has a separate set of tasks to complete for the entire system. It should be understood that the logic embodied in the form of software instructions or firmware may be executed on any applicable hardware which may be a dedicated system or systems, or a personal computer system, or distributed processing computer system.

The software tasks completed by the wireless sensor nodes are (1) retrieving sensor data and (2) transmitting the local time to the base station when vehicles are sensed.

The base station software performs the following tasks: (1) predictive time span calculations; (2) combinational logic for collision detection for two or more cars; and (3) signaling to the warning system.

The base station transceiver node performs: (1) reception of all incoming packets from vehicle detection nodes; (2) retransmission to the host PC rack and (3) synchronization of all vehicle detection nodes.

The software's primary goal is to detect collisions for approaching vehicles. For the present invention, the warning signal is activated for the possibility that a driver runs the stop sign without slowing down. Additionally, it warns a driver waiting to cross an intersection if non-stopping crossing traffic is approaching at an unsafe distance. Thus, this is a two state warning model. All the subsystems work together for appropriate operation.

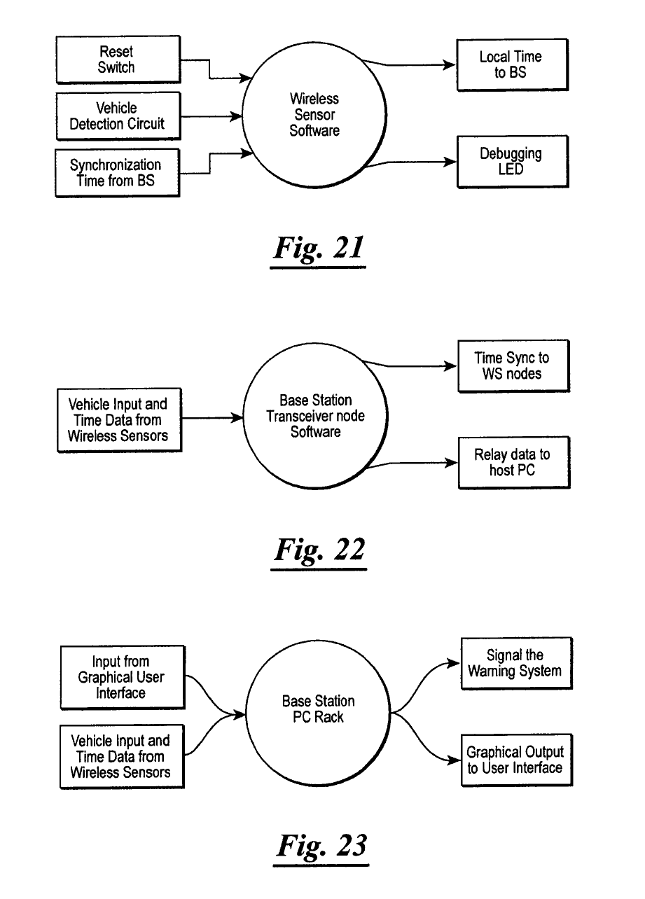

FIG. 21 shows the system context for the sensor node. The vehicle detection sensor node is receiving inputs from reset switches, a vehicle detection sensor circuit, and synchronization transmissions from the base station. The software transmits data to the base station as vehicles are detected and also light an LED array for debugging purposes.

FIG. 22 shows the system context for the base station receiver software. The base station transceiver node is a simple model. It receives transmissions from wireless sensor nodes and retransmits them to the host PC. It also transmits synchronization to the wireless sensor nodes around the intersection.

FIG. 23 shows the system context for the collision detection software. The software for the host PC has two inputs and outputs. It simply receives incoming transmissions and outputs to the warning system. It also gathers user data for initialization from the Graphical User Interface (GUI) and outputs runtime data to the GUI for debugging purposes. It finally performs the important task of outputting to the warning signal device.

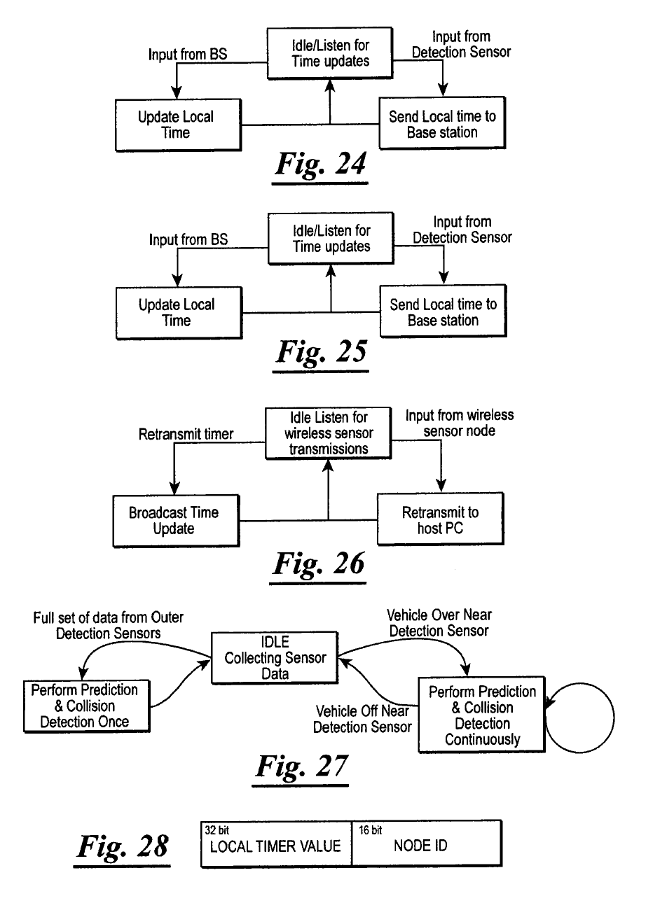

The state transition diagram proves to be a descriptive way of showing the high level structure of the software. A state is defined as a functionally separate set of processes from other portions of the software that are performed only for certain scenarios or inputs. FIG. 24 shows a state transition diagram for the outer wireless vehicle sensor.

The wireless sensor node has a simple model for the state diagram. It operates in an idle listening state until it is interrupted by the vehicle detection sensor or the wireless transceiver. Upon interruption by the transceiver, the system reads packets and updates its local time. Upon input from the detection sensor, it transmits its local time and local address to the base station. After completion of interrupt routines, the system state returns back to the idle listening state.

Since the ICWS 10 may include a vehicle detection sensor node positioned near an intersection, the software state diagram, as shown in FIG. 25, is slightly different for these particular sensor nodes. For the near sensor node, it senses both when a vehicle is stopped over the sensor and when the vehicle leaves. This is important so that the system can detect stopped vehicles at the intersection. Knowing that there are stopped vehicles at the intersection allows the system to detect, for the stopped vehicles, if it is safe to cross the highway. The interrupt in these sensor nodes is triggered from both low to high and high to low states. The system transmits its data in the same packet format as the regular transmission; however, in order for the base station to decipher if a vehicle is stopped and waiting or if it has crossed the intersection, the most significant bit of the local address is set to high in the state where the vehicle is over the sensor.

As shown in FIG. 26, the base station transceiver is another very simple state model. Upon reception of packets from wireless sensor nodes, the system retransmits the packets to the host PC as shown in FIG. 26. The system includes an internal retransmission timer that periodically signals the node to rebroadcast its local time for synchronization of the nodes in the local network. This makes sure that all the node's local timers do not drift very far apart. This also ensures that all nodes are set to the same time, since their local timers are set to different times on startup.

FIG. 27 shows a three state model for the position prediction and collision detection software running on the host PC. The present invention only has a single set of warning lights and two separate states in which it warns motorists. One example of a collision scenario is to prevent stopped vehicles from crossing or merging onto a highway with non-stopping traffic if there is cross-traffic approaching at unsafe distance and speed. Another example is to prevent two drivers that do not recognize the stop signs from colliding at full speed.

One example of the setup of the ICWS 10 includes a plurality of outer vehicle detection sensors preceding the intersection at a distance and, for stopping lanes, a detection sensor near the intersection to detect stopped cars. The outer sensors detect approach speed. When the host PC gets these readings, it performs predictive analysis and detects collisions based on the approach speed. This outer detection leads to the first state in the base station software. This is to mitigate the collisions where drivers do not recognize stop signs. This detection is only performed once. However, once a vehicle stops and the near sensor detects the stopped vehicle, the state of the system changes towards warning the stopped drivers not to cross if there is traffic approaching at an unsafe speed and distance. The collision analysis is performed continuously while the vehicle is stopped. As soon as the vehicle crosses, the state returns back to idle.

The data transferred from each of the plurality of vehicle detection sensor nodes is very simple for the ICWS 10. Whether it is broadcasts from the base station to the outer nodes or vehicle detection transmission information to the base station, all packets have the same two components as shown in FIG. 28.

The first field is the local timer value. This data is a 32 bit value containing the value of the 32 kHz clock on the local node processor. The value is locked into this value once vehicle detection takes place. The base station receives this data and uses it to predict time of entrance and exit on the intersection. Additionally, the base station periodically locks its time into this field and broadcasts it to all outer nodes so that they can synchronize their clocks. The second field is the node ID field which contains the predetermined identification number of the transmitting node. This information is important so that the processing system knows the location of the vehicle detection readings.

These two fields are encapsulated into a larger TinyOS packet field. The extra fields have a MAC layer purposes in the CC2420 radio transceiver. The total packet consists of 22 bytes.

When synchronizing the startup of the ICWS 10, all of the plurality of vehicle detection sensor nodes is set to the same time. Each node transmits its detection time based on its own internal 32 kHz clock. Each clock is a different time upon startup, so each node needs a common frame of reference to determine what time to send. This is provided by the base station. The base station broadcasts a beacon with its local time to all outer nodes. These nodes receive this broadcast at the same time. Once the packet is received, they store the value, calculate the difference between their local times and the base station time, and then store the difference as an offset. When a vehicle passes over the sensor, the value transmitted is the sum of the local time and the offset. Another important concern in synchronization is once the times are synchronized, they need to maintain synchronization. The quartz crystals which control oscillation on the processor clock are not completely accurate. According to Quartz crystal standards, two individual quartz crystals can drift apart between 1 to 100 microseconds every second. For this reason, it is important to ensure that the base station sends out periodic beacons to maintain synchronization. The base station sends out beacons every 2 seconds.

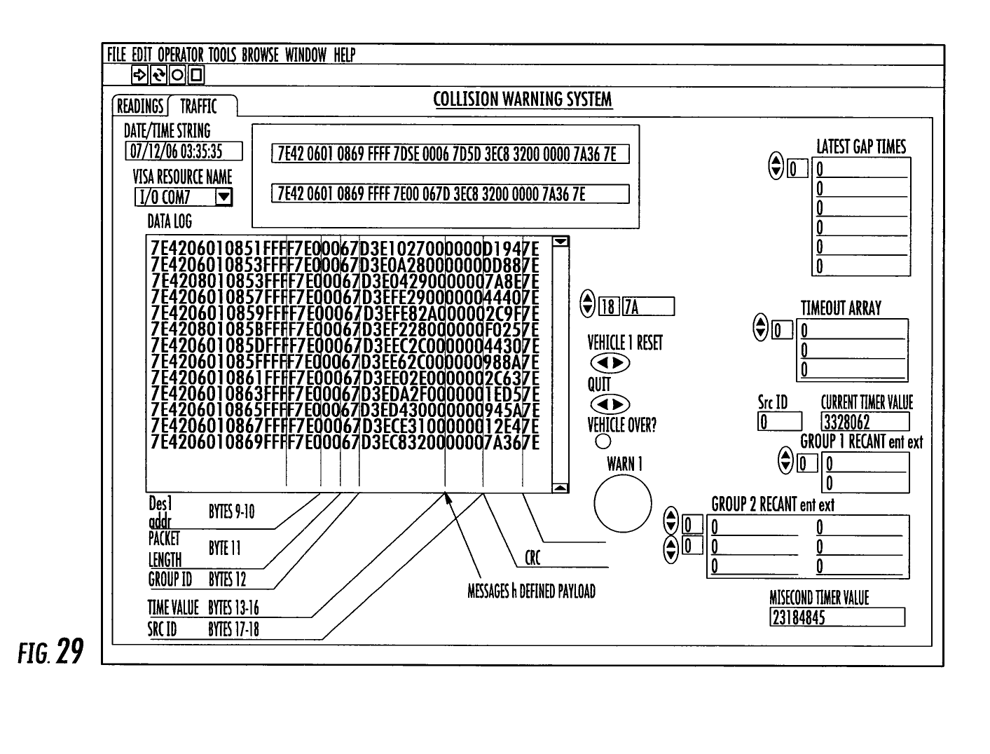

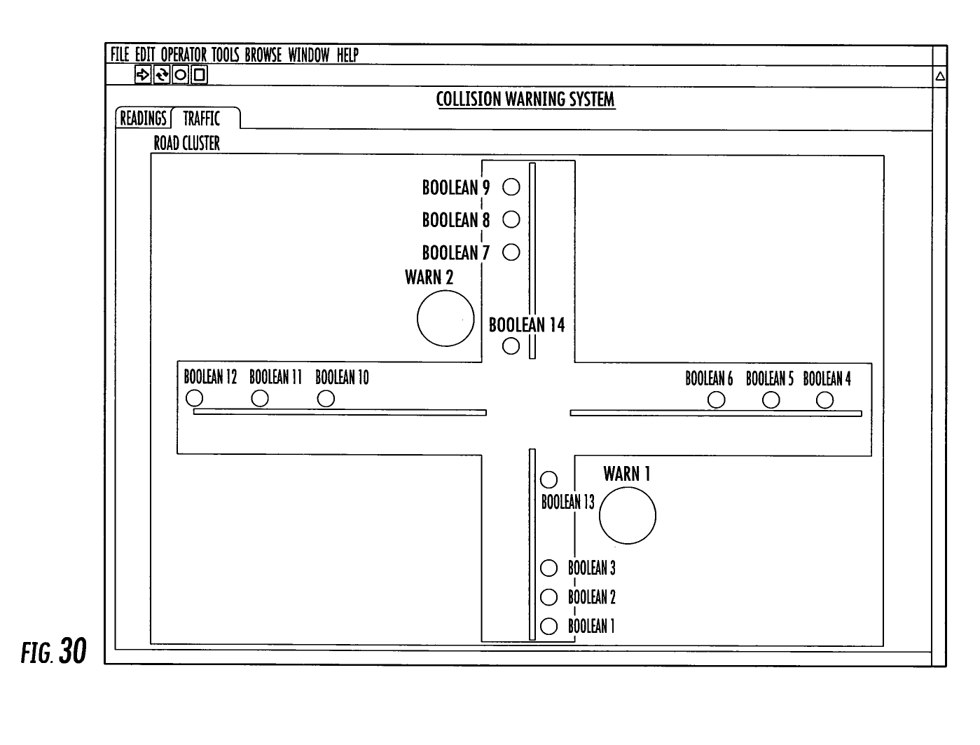

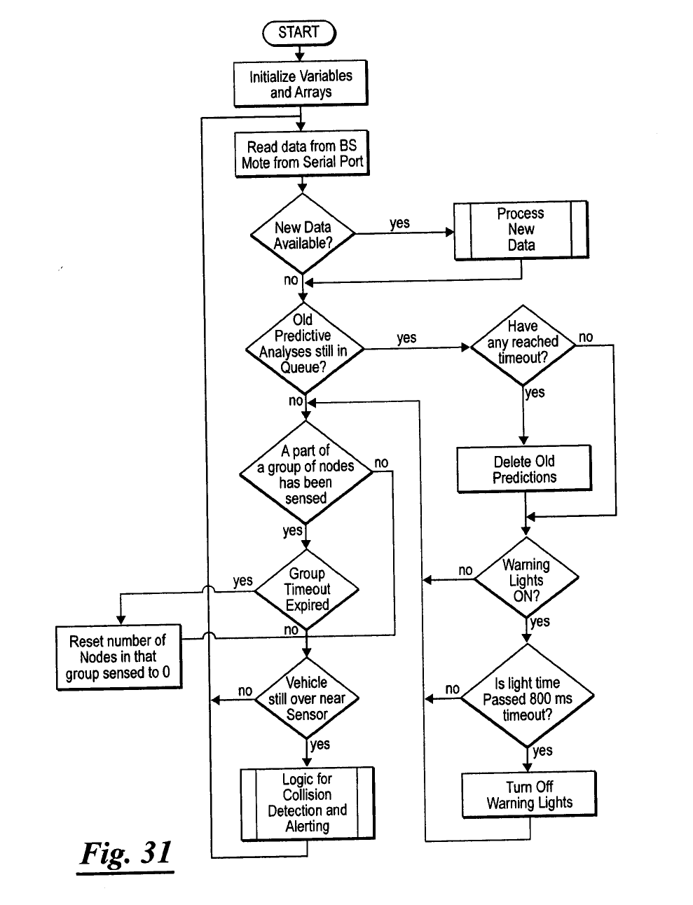

The host PC's software is developed in LabVIEW. LabVIEW has simplistic data acquisition routines and excellent debugging resources. Another advantage of using LabVIEW is its programmer friendly GUI development. National Instruments has provided several driver libraries for various data acquisition routines and mathematical routines. These simplistic routines make development in LabVIEW fairly relaxed. Screenshots of the GUI for the ICWS 10 are shown in FIGS. 29 and 30. The main logical flow for the software is shown in FIG. 31.

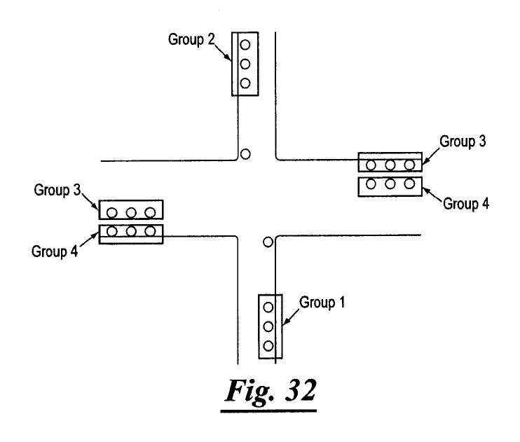

Each lane is equipped with a plurality of nodes for sampling of vehicle approach speed from a safe deceleration distance. Each series of three sensors is defined as a separate sensor group in the software as shown in FIG. 32.

The near detection sensors are not included in the groups since they are used for a separate state. The software considers several different timeouts for robust collision detection. The first timeout value is the warning signal timeout. This timeout value determines how long to leave the warning signal on after a collision is detected before turning it off. The second timeout is the prediction timeout value. This is the amount of time the system keeps a vehicle position prediction in memory for collision detection before deleting it. This value is based on the predicted time the vehicle is expected to exit the intersection. The final timeout value is the group timeout value. This timeout is a robust design consideration. Prediction of vehicle position receives a sample from each of the three sensors in a group. Once the base station receives a single sample from a group, it stores it in a buffer and waits for the other samples in that group to come in before performing prediction. If, for some reason, packets are lost while a vehicle is passing over the sensor group or a sample is sent erroneously due to environmental conditions, the present invention keeps that data until another vehicle crosses. Packets from the new vehicle are mixed with older data which would corrupt the prediction for the new vehicle. To solve this problem, a group timeout value is implemented which has all three samples in the group to be received within a certain time period. This time period is based on the amount of elapsed time expected for a vehicle to cross over the group based on the speed limit. Once this time period is elapsed, the old data is deleted.

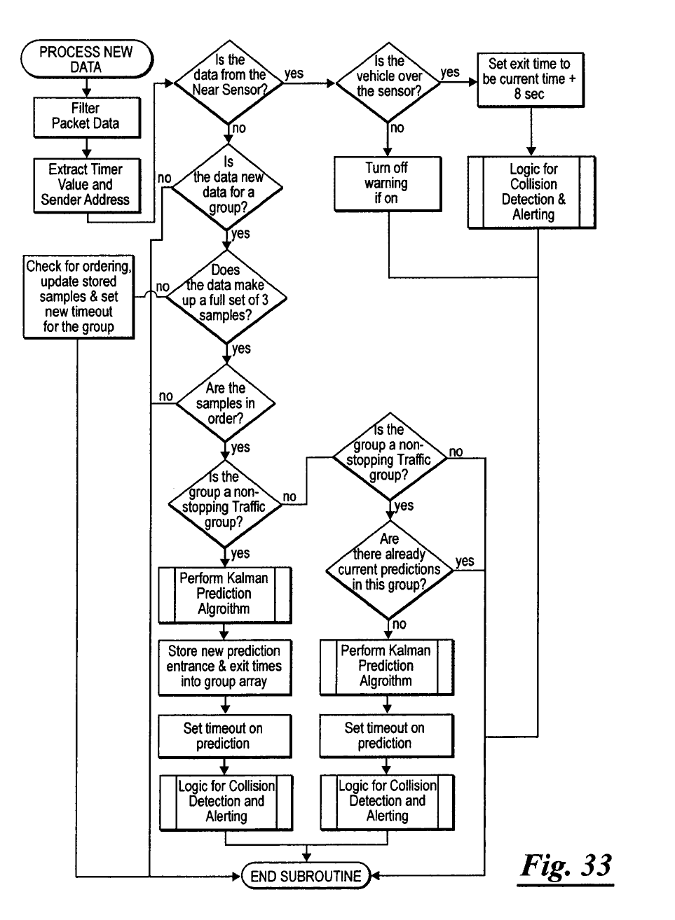

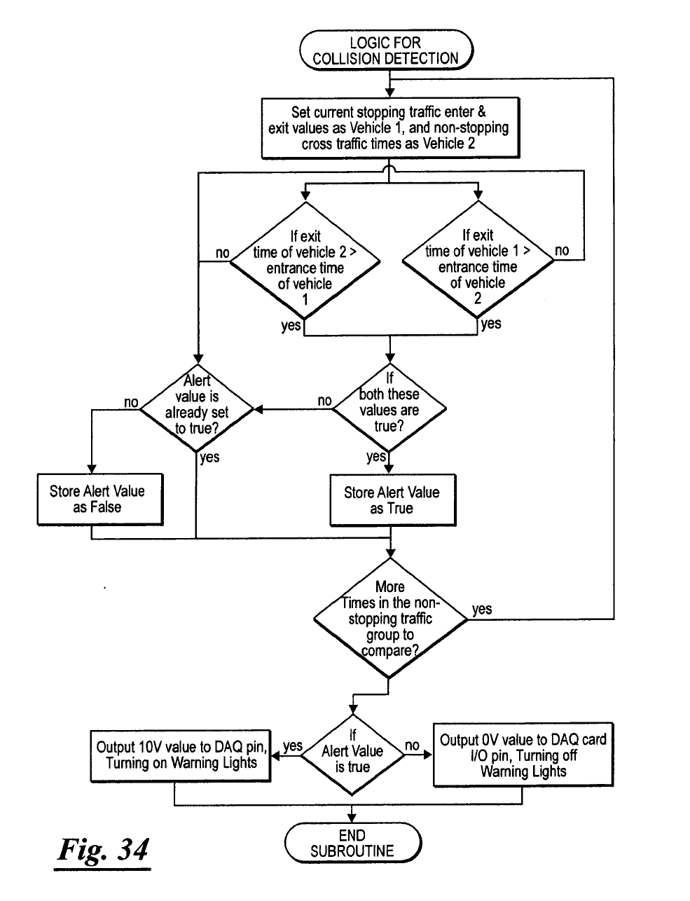

As shown in FIG. 33, the software begins with initialization, and proceeds to read data from the base station transceiver over the USB serial port. If there is data available, it performs a data processing routine. Once these routines are completed, the system handles the timeouts of the variables. If a vehicle is detected to be over one of the sensors near the intersection in the stopping lanes, the logic is performed to predict if it is safe for them to cross. These commands are looped endlessly until the system execution is terminated.

Once the packet is received from the base station transceiver, the desired data is extracted from the packet. The first check the software performs is to determine if the packet is from one of the non-group detection sensors near the intersection. If the packet says that the vehicle is over the sensor, the warning signal is turned off; if on, the sensor returns to its original state. Otherwise, it assumes a stopped vehicle has approximately 8 seconds to cross the intersection safely, and set that as the exit time and the entrance time as the current time. The 8 seconds time is based on estimated crossing times from stop for normal vehicles accelerating at a typical pace. Also, this is assuming the vehicle has to cross four lanes of traffic. Trucks with trailers and busses are of course expected to have a longer crossing period. The current system does not detect vehicle type, so the value cannot be adapted; therefore, it is designed for most normal vehicles and not large class vehicle types. These vehicle types are extra cautious. The number of lanes to be crossed also has an effect on this time and is inputted into the setup of the software. After exit and entrance times are predicted, the logic for collision detection and alert signaling is performed. If the data received is not from the near sensor, the node ID that the transmission was received is translated to determine its group ID. If there is already data for the received node ID in the group, then the data is discarded. This is to filter out multiple samples for one vehicle. If the data is new to the group, the system checks to see if all three sensor readings in that group have been received. If not, the data is buffered; however, if it is, the three sensor readings are sent to the Kalman prediction algorithm. This is used to determine the expected entrance and exit times at the intersection. Additionally, for the traffic that is to be alerted by the warning signals, only the leading car approaching the intersection is to be warned. This is because there is only a single warning signal and, to make sure there is no confusion, only the nearest vehicle to the intersection is warned. If there is already prediction data for a vehicle in the stopping group, then no prediction is performed until that prediction has timed out. If the group is in one of the lanes of non-stopping traffic, then multiple predictions are performed. The single stopping traffic predictions is compared with the array of non-stopping traffic predictions in the logic for detection and alarm signaling. A timeout is set for each prediction coming from the Kalman Prediction Algorithm to release old data that is useless after a period of time.

Another algorithm in the ICWS 10 is the position prediction algorithm. Position of the vehicle is a function of vehicle acceleration and velocity as the vehicle approaches the intersection. These parameters are constantly changing as a result of driver input. The ICWS 10 samples position and velocity at a few points and base the estimation on those points. Utilizing the plurality of vehicle detection sensors, two velocity samples can be attained for position prediction. The elementary approach in determining future position is utilizing linear regression using the Least Squares method to compute the equation of linear motion and compute the time of intersection. The problem with utilizing the Least Squares method is that it is very susceptible to stochastic measurement errors. This results in widely oscillating estimates from one time step to the next.[45] An alternative to using the Least Squares method of position estimation is through the use of Kalman prediction.

The Kalman prediction algorithm is a recursive algorithm for predicting future states of a system. Recently, Kalman filtering has been applied to navigation and motion models in vehicle path prediction. The Kalman filter is a weighted prediction algorithm which takes into account past and present states in determining the future states, as well as expected variances in measurement error. The weighted algorithm acts as a low-pass filter on measurement samples received from sensing devices. This low-pass filter resemblance makes it less sensitive to stochastic errors in the measurement. It is important to set up initial conditions correctly to allow for the greatest accuracy in future prediction.

For the input of the Kalman filter, the system knows the time in which an approaching vehicle crossed each of the three vehicle detection sensors. The distance of the sensors from the intersection is provided in the initialization of the collision detection software. The goal of the prediction is to determine at what time the vehicle reaches and then crosses the intersection. These times are labeled the “entrance” and “exit” time. The distance of the intersection zone is also given in the initialization of the software. For this application, right turn and left turn distances are not considered. The types of crossing path collisions addressed in this research assume vehicles are going straight at an intersection. A single lane on a roadway is around 9 feet in width. This assumes a vehicle crossing two lanes of traffic spanning 18 feet; however, this can be easily changed in the software for any size of intersection. The expected time span of vehicle entrance and exit at an intersection is provided as an input to the collision detection algorithm.

The Kalman prediction algorithm is performed once all readings from a sensor group have been received after a vehicle passes over the group. The algorithm is not performed when a vehicle is stopped at the stop sign over the near sensor. In this scenario the entrance time is set to the recent timer value of the system and the exit time is 8 seconds from the current time to give vehicles ample time to cross safely. Crossing vehicle entrance and exit times are still determined by the Kalman prediction estimator in these scenarios.

Once the predictive analysis has been performed for a vehicle passing over a group of sensors, the logic for collision detection is performed to determine if the vehicle is on a collision course with any other vehicles sensed by the system. FIG. 34 shows the routines performed by the collision detection algorithm.

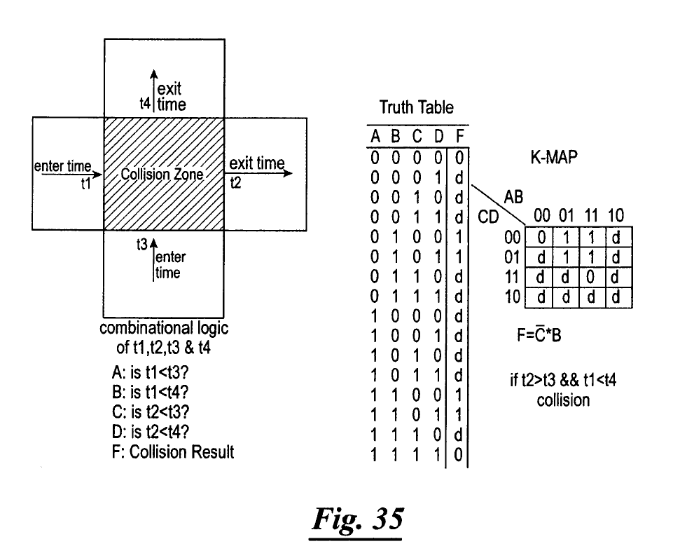

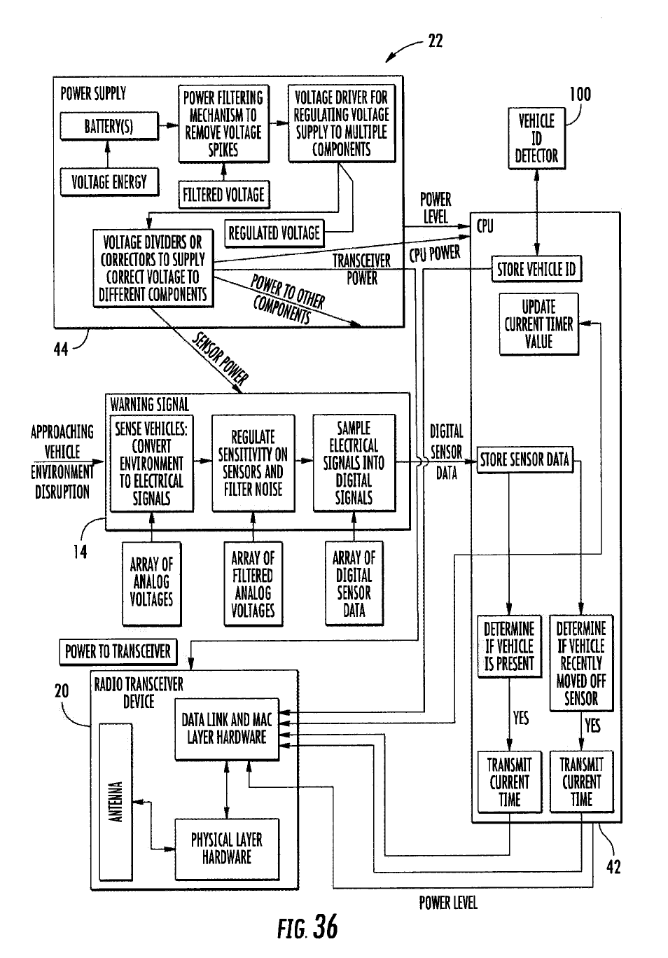

The collision detection logic performs collision logic on predicted times taking two vehicles at a time. Once a single vehicle has been compared with all other vehicles in the prediction buffer, the detection logic is completed. The system has to compare predicted entrance and exit times of each vehicle to detect collisions. The logic for this is shown in FIG. 35.

The only way a collision occurs is if the predictions occur where entrance time of one vehicle is less than the exit time of another, and the entrance time the other vehicle is less than the entrance time of the first. For example, vehicle A enters an intersection before vehicle B exits and vehicle B enters before vehicle A exits. This ensures that both vehicles are in the collision zone at the same time. There is some buffer time programmed in to allow for some breathing room for vehicles to pass between each other. This buffer time is based on the prediction error. If the logic results show that a collision is imminent, then it stores the alert value as true. If any of the possible vehicle adversaries are on a collision course, the signal is set to alert the drivers to be sure to stop and not cross until crossing traffic danger is not present.

The collision alert signal is turned on when a new collision is detected by the logic algorithm. It is designated for the vehicle closest to the intersection. Approaching vehicles behind the closest may be on a collision course with others but, since it is preceded by another vehicle, it is not warned. If a new collision is detected for a vehicle approaching a stop sign, the warning signal is turned on and stays on for 800 ms and turns off until another collision is detected. However, if the vehicle is over a near sensor, then it stays on indefinitely until there are no vehicles approaching in close proximity, or the vehicle has left the near sensor.

In use, each of the plurality of vehicle detection sensor nodes 22 are placed in or beside a road and include the vehicle detection sensor 14 and the transceiver 20 which fits easily inside a plastic box. The vehicle position and speed information is passed from each of the plurality of vehicle detection sensor nodes 22 to the base station 16. The base station 16 is positioned close to the intersection, so it can easily send and receive wireless data from all nodes. The output of the system is the warning signal from the warning signal apparatus 18 which is embedded into the pavement or mounted on or near a warning or stop sign. The warning signal apparatus 18 may be beacon lights containing low power LED lights which may also be solar powered or may operate on a backup battery.

Each of the vehicle detection sensor nodes 22 are equipped with real-time clocks and are synchronized by the base station 16. When a sensor 14 detects a vehicle, it generates and transmits a network packet to the base station 16. The packet includes the time at which the vehicle is detected. Therefore, as a vehicle approaches the intersection, the first sensor in the vehicle path detects it; the second sensor determines its speed; the third sensor updates its speed value.

The vehicle position and speed is calculated by the base station 16 using the Kalman navigation model. The model predicts the future position of the vehicle based on current measurements. Using the Kalman predictive position analysis, a logic algorithm is executed to calculate if oncoming vehicles are on a collision course. If a collision is imminent, then the warning signal apparatus 18 is activated the warning signal emits for a short period of time to warn approaching drivers to slow down and stop.

The first vehicle detection sensor is placed at the distance calculated and each subsequent vehicle detection sensor is installed in the road at 5 m intervals. It should be understood that the distance between vehicle detection sensors may be any interval necessary to function in accordance with the present invention. Separate sensor arrays are installed for each lane of traffic. The sensor distances from the intersection are input into the user interface, as well as the number of approaching lanes and intersection configuration. The distance of the intersection is also factored in to the equation to determine both entrance and exit times. The length of the intersection is inputted into the user interface as well. Repeaters are placed at appropriate locations to relay transmissions for long distances. Once installation has been completed, the vehicle detection sensors are calibrated. Each vehicle detection sensor contains a set/reset switch that resets the polarity of the Wheatstone bridge allowing for maximum sensitivity. Eventually sensors are reset due to environmental effects. The hardware can perform this using a relay switch and internal node software. The sensitivity of the magnetic sensor is calibrated to allow for maximum reliability on vehicle detection. This is performed by trimming the potentiometers so that the sensitivity is maximized. After calibrating sensors and inputting the information into the user interface, the system is ready to be tested.

Attached hereto are various materials illustrating and describing the operation of one embodiment of the present invention. It should be understood that changes may be made in the operation and the setup of such embodiment.

The ICWS 10 has various other applications. The ICWS 10 has the potential to be used as a traffic management system. For example, the ICWS 10 could be used for counting the number of vehicles traveling on a specific highway and their rate of speed. Additionally, vehicle classification can be built into the ICWS 10, so that the customers are able to note the types and size of vehicles traveling on the roads. These systems are already in place in many highways and city streets throughout the nation. Departments of Transportation use this information for a variety of analyses. The data is used for multiple applications such as determining when a city needs to widen roads or the need for traffic lights.

In addition, the ICWS 10 can be used on railway intersections as well. The ICWS 10 vehicle detection sensor could detect on-coming trains from a specified point, and then light the beacon up to warn crossing traffic automobiles of the on-coming train. This system can effectively decrease the amount of train/automobile accidents per year. The ICWS 10 could be strategically placed in rural areas that lack proper rail road intersection crossings.

It should be understood that the processes described above can be performed with the aid of a computer system running processing software adapted to perform the functions described above, and the resulting images and data are stored on one or more computer readable mediums. Examples of a computer readable medium include an optical storage device, a magnetic storage device, an electronic storage device, or the like. The term computer system as used herein means a system or systems that are able to embody and/or execute the logic of the processes described herein. The logic embodied in the form of software instructions or firmware may be executed on any appropriate hardware which may be a dedicated system or systems, or a general purpose computer system, or distributed processing computer system, all of which are well understood in the art, and a detailed description of how to make or use such computers is not deemed necessary herein. When the computer system is used to execute the logic of the processes described herein, such computer(s) and/or execution can be conducted at a same geographic location or multiple different geographic locations. Furthermore, the execution of the logic can be conducted continuously or at multiple discrete times. Further, such logic can be performed about simultaneously, or thereafter or combinations thereof.

### Warning Signal Apparatus in Vehicle

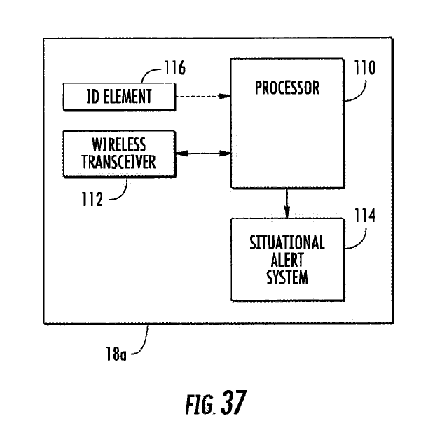

Referring now to FIG. 36, shown therein is another embodiment of a vehicle detection sensor node 22a constructed in accordance with the present disclosure. The vehicle detection sensor node 22a is identical in construction and function as the vehicle detection sensor node 22 discussed above, with the exception that the vehicle detection sensor node 22a is provided with a vehicle ID detector 100 having circuitry to automatically detect a vehicle identification of a passing vehicle. Similar elements between the vehicle detection sensor node 22 and the vehicle detection sensor node 22a are labeled in FIG. 36 for purposes of clarity. In general, the vehicle ID detector 100 detects the vehicle identification and then provides the vehicle identification to the CPU 42, which stores the vehicle identification and then forwards the vehicle identification to the wireless transceiver 20 for transmitting the vehicle identification to the base station 16.

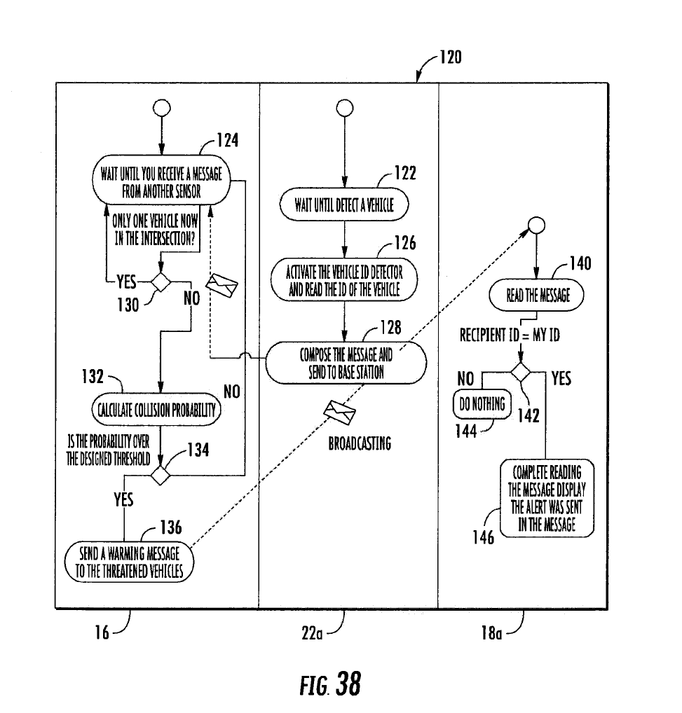

The vehicle ID detector 100 can be implemented in a variety of forms so long as the vehicle ID detector 100 functions to identify particular vehicles such that a warning signal can be transmitted from the base station 16 to a warning signal apparatus 18a (a block diagram of which is shown in FIG. 37) carried by the vehicle. For example, the vehicle ID detector 100 can be implemented as a radio frequency identification (RFID) scanner including circuitry to read a passive and/or an active radio frequency identification tag mounted to the vehicle. Preferably, the vehicle ID detector 100 will have a sleep mode to save power and may be switched to an active mode upon detection of a vehicle via the vehicle detection sensor 14.

Further, the vehicle detection sensor node 22a also differs from the vehicle detection sensor node 22 in that the CPU 42 monitors a power level of the power supply 44 and then transmits instantaneous values of the power level to the base station 16 to keep the base station 16 aware of the power level in each of the vehicle detection sensor nodes 22a. When the power level of a particular vehicle detection sensor node 22a falls below a predetermined and/or dynamic threshold, the base station 16 may output an alert to notify an operator of the need to replenish the power level of the power supply 44.

Shown in FIG. 37 is a block diagram of the warning signal apparatus 18a discussed above that is mounted to the vehicle for warning the driver of the vehicle of an imminent collision in order to avoid such collision. In general, the warning signal apparatus 18a is provided with a processor 110, a wireless transceiver 112, an situational alert system 114, and an ID element 116. The ID element 116 can be a passive and/or an active RFID tag. When the ID element 116 is a passive RFID tag, then such passive RFID tag will include circuitry to store a unique vehicle ID, obtain power from the vehicle ID detector 100 and transmits the vehicle ID to the vehicle ID detector 100. When the ID element 116 is an active RFID tag, then such active RFID tag will include circuitry to store the unique vehicle ID, as well as to broadcast and/or transmit the unique vehicle ID to the vehicle ID detector 100 using radio frequency signals preferably aimed at the road. The ID element 116 can be implemented in the form of a sticker or a thin plate that can be connected to the underside of the vehicle's rear bumper. The ID element 116 can be connected using any suitable device, such as pressure sensitive adhesive, a cohesive, and/or one or more screws.

The wireless transceiver 112 is adapted to receive the warning signal from the base station 16. The warning signal from the base station 16 includes vehicle identification signals identifying vehicles which have been determined to be on course for an imminent collision utilizing the techniques described above, for example. The warning signal, including the vehicle identification signals, is provided to the processor 110 which compares the vehicle identification signals to a vehicle identification of the vehicle stored by the ID element 116. Comparing can be accomplished by direct comparison, or by looking up values from a table, or the like to determine whether one of the vehicle identification signals match the vehicle identification. If one or more of the vehicle identification signals matches the vehicle identification of the vehicle in which the warning signal apparatus 18a is mounted, then the processor 110 enables the situational alert system 114 to issue an alert to the driver. The situational alert system 114 can be implemented in a variety of manners to notify the driver. For example, the situational alert system 114 can be a light or sound signal perceivable by the driver. The situational alert system 114 can be provided in a cab of the vehicle to provide visual or sound based warnings or information. The situational alert system 114 can include one or more control circuits and/or drivers as well as one or more warning devices, such as L.E.D.s, LCDs, and/or a speaker. The situational alert system 114 can produce flashing lights on the vehicle's dash, a warning buzzer, information on a displayed map, and/or a voice that is broadcasted via the vehicle's sound system and/or other method to warn the driver of the imminent collision so that action can be taken to avoid same.

Shown in FIG. 38 is a flow chart of a process 120 for predicting a collision between two or more vehicles moving toward the collision area 12 and providing a warning to the warning signal apparatus 18a within the two or more vehicles to avoid an imminent collision. The vehicle detection sensor nodes 22a are mounted to the road in a similar manner as the vehicle detection sensor nodes 22 discussed above. In general, the process 120 starts with steps 122 and 124 with the vehicle detection sensor nodes 22a and the base station 16 waiting until one or more signals are received indicative of the detection of one or more vehicles. In particular, the vehicle detection sensor nodes 22a wait until the detection sensors 14 detect a vehicle passing over or near the detection sensors 14 as discussed above. The process 120 then branches to a step 126 where the vehicle ID detector 100 is switched from a sleep mode to the active mode to read the vehicle identification from the ID element 116. In a preferred embodiment, this can be accomplished by the vehicle detection sensor 14 communicating with the CPU 42 indicating that a vehicle has been detected. The CPU 42 may be awaked from its sleep mode by an interrupt. The CPU 42 wakes the vehicle ID detector 100 its sleep mode and then the vehicle ID detector 100 would scan the ID element 116 carried by the vehicle and send the vehicle identification to the CPU 42 which will compose a message preferably including a node identification identifying the vehicle detection sensor node 22a, the vehicle identification, time data (optionally including a time offset for synchronization purposes), and position data to the base station 16 through the wireless transceiver 20 in a step 128.

The base station 16 receives the messages from the various vehicle detection sensor nodes 22a and then branches to a step 130 to determine whether only one vehicle is predicted to be in the collision area 12 and if so, the process 120 branches back to the step 124. However, if more than one vehicle is predicted to be in the collision area 12, then the process 120 branches to a step 132 where the base station 16 calculates a probability of collision between two or more vehicles. The process 120 then branches to a step 134 where the calculated probability of collision is compared to a threshold and if such calculated probability of collisions exceeds the threshold, then the process 120 branches to a step 136 where the base station 16 sends a warning signal including vehicle identification of two or more vehicles having a probability exceeding the threshold of being in an imminent collision.

Every warning signal apparatus 18a near the collision area 12 will receive the warning signal and read the vehicle identification(s) within the warning signal as indicated by a step 140. Each of the warning signal apparatus 18a then compares the received vehicle identification(s) with its own vehicle identification at a step 142. If the received vehicle identification(s) do not match the warning signal apparatus 18a's own vehicle identification, then the process 120 branches to a step 144 where the warning signal apparatus 18a does nothing. However, if one of the received vehicle identification(s) matches the warning signal apparatus 18a's own vehicle identification, then the warning signal apparatus 18 actuates the situational alert system 114 to warn the driver of the vehicle had a step 146. RFID. If it finds its own RFID, an alert will be launched. Optionally, the warning signal could also be transmitted to the warning signal apparatus 18 to provide another manner of warning the drivers of an imminent collision.

It should be noted that the time for waking up the vehicle ID detector 100 should be less than the time needed for the vehicle to exit an ID scan area where vehicle ID detector 100 can scan and/or read the ID element 116. For example, the time for waking up the vehicle ID detector 100 may be less than 30 microseconds. Preferably, the ID element 116 will be mounted at the rear of the vehicle (e.g., within the rear 25% of the length of the vehicle) to enhance the probability that the ID element 116 will be scanned and/or read by the vehicle ID detector 100. For example, the ID element 116 can be mounted to a rear bumper of the vehicle.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

The following references, to the extent that they provide exemplary procedural or other details supplementary to those set forth herein, are specifically incorporated herein by reference in their entirety as though set forth herein in particular.

### REFERENCES

[1] National Highway Traffic Safety Administration (NHTSA). Traffic Safety Facts 2004: A Compilation of Motor Vehicle Crash Data from the Fatality Analysis Reporting System and the General Estimates System. U.S. Department of Transportation.
[2] Bared, J. G. & Hasson, P. & Ranck, F. N. & Kalla, H. & Ferlis, R. A. & Griffith, M. S. 2003. Reducing Points of Conflict. Public Records, 66 (4): 26.
[3] Moore, Angela. “1 killed when car, tanker collide” St. Petersburg Times. Mar. 23, 2000
[4] R. Deering, M. Shulman, R. Lange, J. Vondale. “Crash Avoidance Metrics Partnership—Response to Performance of Advanced Crash Avoidance Systems; Request for Information.” Docket No. NHTSA—2005-21858-6. Aug. 17, 2005.
[5] Ashkan Sharafsaleh, Ching-Yao Chan. “Experimental Evaluation of Commercially-off-the-Shelf Sensors for Intersection Decision Support Systems.” Paper No. 1925. 12th World Congress on ITS, San Francisco. Nov. 6-10, 2005.
[6] Ching-Yao Chen, et al. “California Intersection Decision Support: A Systems Approach to Achieve Nationally Interoperable Solutions.” California PATH Research Report for Task Order 4403. April 2005. http://www.its.berkeley.edu/publications/UCB/2005/PRR/UCB-ITS-PRR-2005-11.pdf
[7] Füsun Özgüner, et al. “A Simulation Study of an Intersection Collision Warning System.” in International workshop on ITS Telecommunications Proceedings, Singapore. June 2004.
[8] Umit Ozguner. “Advanced Safety Issues in the Car and Human Interface Implications” in ICAT International Conference on Automotive Technology Proceedings, Istanbul, Turkey. 2004
[9] James A. Misener, Raja Sengupta. “Cooperative Collision Warning: Enabling Crash Avoidance with Wireless Technology.” Paper No. 1960. 12th World Congress on ITS, San Francisco. Nov. 6-10, 2005.
[10] Ulrich Lages. “Intersafe a PReVENT Project.” Presentation from 9th International Task Force on Vehicle-Highway Automation. San Francisco. Nov. 5-6, 2005. http://www.prevent-ip.org/download/Events/20051105%20ITFVHA%20San%20Francisco/ITFVH A05_EUR_PReVENT_INTERSAFE%5B1%5D. pdf
[11] “Delphi Forewarn® Smart Cruise Control with Headway Alert & Stop-and-Go.” 2005. http://delphi.com/manufacturers/auto/safesecure/warning/stopgo/
[12] “Radar Fundamentals. Ch. 7 Radar Principles” Introduction to Naval Weapons Engineering. http://www.fas.org/man/dod-101/navy/docs/es310/radarsys/radarsys.htm
[13] Figure courtesy of Massachusetts Highway Department Project Development & Design Guide. Ch. 6. 2006. www.vhb.com
[14] Surveillance, Monitoring and Prediction: Technology. FHWA Road Weather Management Program. http://www.ops.fhwa.dot.gov/weather/mitigating_irnpacts/surveillance.htm
[15] Mike Leidemann. “Courteous driving can be bad habit.” The Honolulu Advertiser. Jul. 26, 2004. http://the.honoluluadvertiser.com/article/2004/Jul/26/In/In03a.html
[16] Clipart Courtesy of Funet Collection. Cars & Trucks. Retrieved, Mar. 2006 http://www.go.dlr.de/wt/dv/ig/icons/funet.html
[17] Howard Preston. “Integration of Performance Measures in Corridor Planning.” 6^{th} National Access Management Conference. Kansas City. Aug. 30, 2004.
[18] Moe, Michelle. “ I-135, 61^{st} St. areas most dangerous intersection” Ark valley News. Dec. 20, 2001
[19] Peter Carr. “Installation of Traffic Light at Erie Street Intersection.” The Journal News. September 2005. http://www.thejournalnews.com/dailygallery/092305/pages/24.htm
[20] “Won't a Flashing Yellow Light Draw More Attention to a Sign?” Traffic Safety and Informational Series: FAQ #15. Bexar County Traffic Safety Coordinator. August 2005. http://www.bexar.org/bcinf/About_Infrastructure/Public_Works/Traffic_FAQ/Traffic_FAQ15.pdf.
[21] “An Evaluation of a Crosswalk Warning System Utilizing In-Pavement Flashing Lights.” Whitlock & Weinberger Transportation Inc. Apr. 10, 1998 http://www.lightguardsystems.com/html/reports_evaluation.html
[22] Clipart is adapted from Voltswagen Guaranteed Used Car. http://www.volkswagen.co.jp/cars/GUC/whatis.html
[23] R. Parasuraman, P. A. Hancock, O. Olofinboba. “Alarm Effectiveness in Driver-Centred Collision-Warning.” Ergonomics. Vol. 40, No. 3. 390-399. 1997
[24] P. Dutta. “On Random Event Detection with Wireless Sensor Networks.” Ohio State University Thesis. Electrical and Computer Engineering. 2004.
[25] “Comprehensive Truck Size and Weight Study Final Report” FHWA study. Vol. 2, Ch. 3. August 2000. http://www.fhwa.dot.gov/reports/tswstudy/TSWfinal.htm
[26] K. A. Brookhuis, D. DeWaard, S. H. Fairclough. “Criteria for Driver Impairment” Ergonomics. Vol. 46, No. 5, 433-445, 2003
[27] Haig Krikorian. “Functionality Quality Attribute.” Nov. 1 2003. http://haig.ecs.fullerton.edu/files/Software%20Architecture/
[28] L. E. Mimbela, L. Klein. “A Summary of Vehicle Detection and Surveillance Technologies used in Intelligent Transportation Systems.” Vehicle Detection Clearing House. Nov. 30, 2000. http://www.nmsu.edu/˜traffic/
[29] “Application Note—AN218: Vehicle Detection Using AMR Sensors.” Honeywell. August 2005. http://www.ssec.honeywell.com/magnetic/datasheets/an218.pdf
[30] “Datasheet HMC1021 Magnetic Sensors.” Honeywell. www.honeywell.com.
[31] Thomas Diekmann, Anders Stenman. “Brake Performance Monitoring (BPM) for Commercial Vehicles using Estimated Tire/Road Friction Information. Pronode-Chauffeur. www.chauffer2.net.
[32] Jun Wang. “Operating Speed Models for Low Speed Urban Environments Based on In-Vehicle GPS Data.” Georgia Institute of Technology Dissertation. May 2006.
[33] Marc Green. “How Long Does It Take To Stop? Methodological Analysis of Driver Perception-Brake Times” Transportation Human Factors, 2, pp 195-216, 2000. http://www.visualexpert.com/Resources/reactiontime.html
[34] “General Rules Techniques and Advice for All Drivers and Riders.” 2004. highwaycode.gov.uk.
[35] Jain, Vivek. “Enhancing Network Throughput in Wireless Ad Hoc Networks using Smart Antennas.” http://www.ececs.uc.edu/˜jainvk/GM.ppt
[36] “Wireless Communications and the TinyOS Radio Stack.” Crossbow. Wireless Communications. Crossbow Smart Dust Seminar, November 2004.
[37] Jason Hill. “System Architecture for Wireless Sensor Networks.” University of California, Berkeley, Dissertation. Computer Science. Spring 2003.
[38] Polastre, Szewczyk and Culler. “Telos: Enabling Ultra-Low Power Wireless Research.” University of California Berkeley. http://www.cs.berkeley.edu/˜polastre/papers/spots05-telos.pdf
[39] Terry Hubler. “Worry-Free Wireless Networks.” HPAC Engineering Magazine. October 2005.
[40] L. Itti, P. Baldi. “Bayesian Surprise Attracts Human Attention.” Neural Information Processing Systems, 2005
[41] Franconeri, Hollingsworth, Simons. “Do New Objects Capture Attention?” Psychological Science. Vol. 16, No. 4. June 2004.
[42] E. Scott, H. Bewley. “Spectral Selectivity: Color Vision.” 1997. http://www.photo.net/learn/optics/edscott/vis00010.htm.
[43] C. Ho, C. Spence, H. Tan. “Warning Signals Go Multisensory.” In Proceedings of the 11th International Conference on Human-Computer Interaction (Vol. 9—Advances in Virtual Environments Technology: Musings on Design, Evaluation, & Applications), Mahwah, N J: Lawrence Erlbaum Associates, Las Vegas, Nev., Jul. 22-27, 2005.
[44] Jeremy Elson. “Time Synchronization in Wireless Sensor Networks.” University of California-Los Angeles, Dissertation. Computer Science. 2003.
[45] Hazem. H. Refai, S. Yang*, and J. J. Sluss, “Auto-Collision Avoidance System Using DGPS”, Gyroscopy and Navigation, No3 (46), pp. 82-83, 2004.
[46] P. Lamb, S. Thiebaux. “Avoiding Explicit Map-Matching in Vehicle Location.” CSIRO Mathematical and Information Sciences. 6th ITS World Congress (ITS-99), Toronto (Canada), November 1999.
[47] “Federal-Aid Highway Length, Classified by Lane Width.” FHWA Report. 2000. http://www.fhwa.dot.gov/ohim/hs00/re.htm
[48] Image courtesy of Traffic Safety Corp. Product Catalog. 2006. www.xwalk.com
[49] Image courtesy of Traffic Parking and Control Co., Inc. Product Catalog. 2006. www.tapconet.com
[50] Image courtesy of Radio Shack Product Catalog. 2006. www.radioshack.com
[51] Image courtesy of Northern Technologies Product Catalog. 2006. www.northern-tech.com
[52] Figure adapted from “TS AIInGapLED Amber Lamps.” Online Report 2005. http://www.lightguardsystems.com/html/reports_ts.html
[53] Figure adapted from “NYS DMV Driver's Manual.” Ch. 11. http://www.nydmv.state.ny.us/dmanual/chapter11-manual.htm
[54] C. R. Murthy, B. S. Manoj. Ad Hoc Wireless Networks Architectures and Protocols. Prentice Hall PTR. New Jersey. 2004. p. 7-8.
[55] Halliday, Resnick, Walker. Fundamentals of Physics, 6^{th} ed. Wiley. N.Y. 2001. p. 937-938.
[56] “Wireless Communication Analyzers WCA230A, WCA280A datasheet” Tektroniks. 2004. http://www.tek.com/site/ps/37-16437/pdfs/37W_{—}16437.pdf
[57] John Lygeres, Maria Prandini. “Aircraft & Weather Models for Probabilistic Collision Avoidance in Air Traffic Control.” From Proceedings in 41^{st} IEEE Conference on Decision and Control. Las Vegas. December 2002.
[58] “Six ITS Collision Avoidance Countermeasures for Preventing Crossing Path Crashes at Intersections.” FHWA Final Report. http://www.its.dot.gov/ivi/docs/finalreport_files/appendixc.htm
[59] Telos Rev. A and Rev. B Datasheets. NodeIV Corp. 2005. www.nodeiv.com
[60] R. Brown, P. Hwang. Introduction to Random Signals and Applied Kalman Filtering, 2^{nd} Ed. Wiley, N.Y. 1983. p. 230-236, 330-331.
[61] J. Thorn. “Deciphering TinyOS Serial Packets.” Octave Tech. Brief #5-01. Mar. 10, 2005. http://www.octavetech.com/newsroom/pubs.html.
[62] “Wireless Communications and the TinyOS Radio Stack.” Crossbow. Wireless Sensor Networks Training Presentation. Beijing. Mar. 9-10, 2005. http://www.ktme.com/

What is claimed is:

1. A system for predicting a collision in an intersection having at least two lanes entering the intersection, the system comprising:
a first group of vehicle detection sensor nodes positioned on one of the lanes preceding the intersection for detecting and transmitting time and position data of a first vehicle, the first group of vehicle detection sensor nodes including at least three sensor nodes positioned in the path of the first vehicle at known distances apart and to the intersection;
a second group of vehicle detection sensor nodes positioned on another lane preceding the intersection for detecting and transmitting time and position data of a second vehicle, the second group of vehicle detection sensor nodes including at least three vehicle detection sensor nodes positioned in the path of the second vehicle at known distances apart and to the intersection;
a base station receiving the time and position data of the first and second vehicles from the first and second group of vehicle detection sensor nodes so as to determine a position, speed and speed update of the first and second vehicles to determine the probability of the first and second vehicles colliding, the base station transmitting a warning signal when the probability exceeds a threshold; and
a warning signal apparatus positioned preceding the intersection, the warning signal apparatus receiving the warning signal from the base station to alert a driver of one of the first and second vehicles of an imminent collision.

2. The system of claim 1 wherein at least one of the vehicle detection sensor nodes includes a wireless transceiver.

3. The system of claim 1 wherein the vehicle detection sensor nodes are embedded in the roadway.

4. The system of claim 1 wherein the vehicle detection sensor nodes are positioned on the side of a roadway.

5. The system of claim 1 wherein each of the vehicle detection sensor nodes are synchronized to the same time of the base station.

6. The system of claim 1 wherein the base station is remotely located from at least one of the plurality of vehicle detection sensor nodes.

7. The system of claim 1 wherein the base station is protected in housing.

8. The system of claim 1 wherein the warning signal apparatus is a visual stimulus.

9. The system of claim 9 wherein the visual stimulus is light.

10. The system of claim 1, wherein the vehicle detection sensor nodes include magnetometers adapted to detect magnetic field disruptions.

11. The system of claim 1, wherein the vehicle detection sensor nodes includes inductive loop sensors.

12. The system of claim 1, wherein at least one of the vehicle detection sensor nodes in the first and second groups of vehicle detection sensor nodes includes vehicle ID detectors having circuitry to detect an identification of the first and second vehicles, and wherein the warning signal transmitted by the base station includes the identifications of the first and second vehicles.

13. The system of claim 1, wherein the vehicle ID detectors include radio frequency identification scanners.

14. The system of claim 1, wherein the vehicle detection sensor nodes in the first and second groups have a power supply with a power level, and wherein the vehicle detection sensor nodes read the power level and transmit a signal including the power level.

15. A vehicle detection sensor node, comprising:
a sensor having circuitry to generate a first signal indicative of a position of a vehicle;
a transceiver device;
a vehicle ID detector having circuitry to receive a second signal indicative of an identification of the vehicle; and
a processor enabling the transceiver device to transmit data indicative of the first and second signals.

16. The vehicle detection sensor node of claim 15, wherein the vehicle ID detector includes a radio frequency identification scanner.

17. The vehicle detection sensor node of claim 16, wherein the radio frequency identification scanner includes circuitry to read a passive radio frequency identification tag.

18. The vehicle detection sensor node of claim 16, wherein the radio frequency identification scanner includes circuitry to read an active radio frequency identification tag.

19. A vehicle detection sensor node, comprising:
a sensor having circuitry to generate a first signal indicative of a position of a vehicle;
a transceiver device;
a processor; and
a power supply supplying power to the sensor, the transceiver device and the processor, the power supply having a power level, and wherein the processor enable the transceiver device to transmit information indicative of the first signal and the power level of the power supply.

20. The vehicle detection sensor node of claim 19, further comprising a vehicle ID detector having circuitry to receive a second signal indicative of an identification of the vehicle.

21. The vehicle detection sensor node of claim 20, wherein the vehicle ID detector includes a radio frequency identification scanner.

22. The vehicle detection sensor node of claim 21, wherein the radio frequency identification scanner includes circuitry to read a passive radio frequency identification tag.

23. The vehicle detection sensor node of claim 21, wherein the radio frequency identification scanner includes circuitry to read an active radio frequency identification tag.

24. A method for avoiding a collision, comprising the steps of:
receiving, by a base station, time data, position data and identification signals for first and second vehicles;
determining the probability of the first and second vehicles colliding using the time data and the position data; and
transmitting a warning signal when the probability exceeds a threshold, the warning signal including the identification signals for the first and second vehicles.
